(19) United States
(12) Patent Application Publication
(10) Pub. No.: US 2026/0205571 A1
(43) Pub. Date: Jul. 16, 2026

(54) Method and Apparatus of Candidates Reordering of Inherited Cross-Component Models in Video Coding System

(71) Applicant: MEDIATEK INC., Hsinchu City (TW)

(72) Inventors: Hsin-Yi TSENG, Hsinchu City (TW); Chia-Ming TSAI, Hsinchu City (TW); Cheng-Yen CHUANG, Hsinchu City (TW); Chih-Wei HSU, Hsinchu City (TW); Yi-Wen CHEN, San Jose, CA (US); Ching-Yeh CHEN, Hsinchu City (TW); Tzu-Der CHUANG, Hsinchu City (TW)

(21) Appl. No.: 19/135,496

(22) PCT Filed: Dec. 1, 2023
(86) PCT No.: PCT/CN2023/135779

§ 371 Date: Jun. 4, 2025

Related U.S. Application Data
(60) Provisional application No. 63/386,333, filed on Dec. 7, 2022.

(51) Int. Cl. H04N 19/103; H04N 19/176; H04N 19/186

(52) U.S. Cl. CPC H04N 19/103; H04N 19/176; H04N 19/186

(57) ABSTRACT

A method and apparatus for candidate reordering. According to this method, input data associated with a current block comprising a first-colour block and a second-colour block are received, wherein the input data comprise pixel data to be encoded at an encoder side or data associated with the current block to be decoded at a decoder side. Cross-component prediction candidates are determined. The cross-component prediction candidates are reordered into reordered cross-component prediction candidates, wherein said reordering the cross-component prediction candidates is constrained depending on one or more conditions. A cross-component prediction candidate list is derived by inserting one or more target candidates from the reordered cross-component prediction candidates. The second-colour block is encoded or decoded using prediction data comprising cross-colour prediction generated by applying one of said one or more target candidates to reconstructed first-colour block.

### CROSS REFERENCE TO RELATED APPLICATIONS

The present invention is a non-Provisional application of and claims priority to U.S. Provisional Patent Application No. 63/386,333, filed on Dec. 7, 2022. The U.S. Provisional Patent application is hereby incorporated by reference in its entirety.

### FIELD OF THE INVENTION

The present invention relates to video coding system. In particular, the present invention relates to inheriting cross-component models from candidates in a video coding system.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUS) as a unit to apply prediction process, such as Inter prediction, Intra prediction, etc.

The VVC standard incorporates various new coding tools to further improve the coding efficiency over the HEVC standard. Some new tools relevant to the present invention are reviewed as follows.

### Cross-Component Linear Model (CCLM) Prediction

To reduce the cross-component redundancy, a cross-component linear model (CCLM) (sometimes abbreviated as LM mode) prediction mode is used in the VVC, for which the chroma samples are predicted based on the reconstructed luma samples of the same CU by using a linear model as follows:

$${pred}_{c} ( i , j ) = α \cdot {rec}_{L}^{′} ( i , j ) + β \qquad ( 1 )$$

where pred_{C}(i,j) represents the predicted chroma samples in a CU and rec_{L}′(i,j) represents the down-sampled reconstructed luma samples of the same CU.

The CCLM parameters (α and β) are derived with at most four neighbouring chroma samples and their corresponding down-sampled luma samples. Suppose the current chroma block dimensions are WxH, then W′ and H′ are set as
W′=W, H′=H when LM_LA mode is applied;
W′=W+H when LM_A mode is applied;
H′=H+W when LM_L mode is applied.

The above neighbouring positions are denoted as S[0, −1] . . . . S[W′−1, −1] and the left neighbouring positions are denoted as S[−1, 0] . . . . S[−1, H′−1]. Then the four samples are selected as
S[W′/4, −1], S[3*W′/4, −1], S[−1, H′/4], S[−1, 3*H′/4] when LM_LA mode is applied and both above and left neighbouring samples are available;
S[W′/8, −1], S[3*W′/8, −1], S[5*W′/8, −1], S[7*W′/8, −1] when LM_A mode is applied or only the above neighbouring samples are available;
S[−1, H′/8], S[−1, 3*H′/8], S[−1, 5*H′/8], S[−1, 7*H′/8] when LM_L mode is applied or only the left neighbouring samples are available.

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$$\begin{matrix}Xa = ( x 0 A + x 1 A + 1 ) ≫ 1 ; \\ Xb = ( x 0 B + x 1 B + 1 ) ≫ 1 ; \\ Ya = ( y 0 A + y 1 A + 1 ) ≫ 1 ; \\ Yb = ( y 0 B + y 1 B + 1 ) ≫ 1\end{matrix} \qquad ( 2 )$$

Finally, the linear model parameters α and β are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b} \qquad ( 4 )$$

FIG. 2 shows an example of the location of the left and above samples and the sample of the current block involved in the LM_LA mode. FIG. 2 shows the relative sample locations of N×N chroma block 210, the corresponding 2N×2N luma block 220 and their neighbouring samples (shown as filled circles).

The division operation to calculate parameter α is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables.

Besides the above template and left template can be used to calculate the linear model coefficients together, they also can be used alternatively in the other 2 LM modes, called LM_A, and LM_L modes.

In LM_A mode, only the above template is used to calculate the linear model coefficients. To get more samples, the above template is extended to (W+H) samples. In LM_L mode, only the left template is used to calculate the linear model coefficients. To get more samples, the left template is extended to (H+W) samples.

In LM_LA mode, left and above templates are used to calculate the linear model coefficients.

To match the chroma sample locations for 4:2:0 video sequences, two types of down-sampling filters are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$${Rec}_{L}^{′} ( i , j ) = [ {rec}_{L} ( 2 i - 1 , 2 j - 1 ) + 2 \cdot {rec}_{L} ( 2 i , 2 j - 1 ) + {rec}_{L} ( 2 i + 1 , 2 j - 1 ) + {rec}_{L} ( 2 i - 1 , 2 j ) + 2 \cdot {rec}_{L} ( 2 i , 2 j ) + {rec}_{L} ( 2 i + 1 , 2 j ) + 4 ] ≫ 3 \qquad ( 6 )$$

$${Rec}_{L}^{′} ( i , j ) = {rec}_{L} ( 2 i , 2 j - 1 ) + {rec}_{L} ( 2 i - 1 , 2 j ) + 4 \cdot {rec}_{L} ( 2 i , 2 j ) + {rec}_{L} ( 2 i + 1 , 2 j ) + {rec}_{L} ( 2 i , 2 j + 1 ) + 4 ] ≫ 3 \qquad ( 7 )$$

Note that only one luma line (general line buffer in intra prediction) is used to derive the down-sampled luma samples when the upper reference line is at the CTU boundary. An exception happens if the top line of the current block is a CTU boundary. In this case, the one-dimensional filter [1, 2, 1]/4 is applied to the above neighbouring luma samples in order to avoid the usage of more than one luma line above the CTU boundary.

This parameter computation is performed as part of the decoding process, and is not just as an encoder search operation. As a result, no syntax is used to convey the α and β values to the decoder.

For chroma intra mode coding, a total of 8 intra modes are allowed for chroma intra mode coding. Those modes include five traditional intra modes and three cross-component linear model modes (i.e., {LM_LA, LM_L, and LM_A}, or {CCLM_LT, CCLM_L, and CCLM_T}). The terms of {LM_LA, LM_L, LM_A} and {CCLM_LT, CCLM_L, CCLM_T} are used interchangeably in this disclosure. Chroma mode signalling and derivation process are shown in Table 1. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the centre position of the current chroma block is directly inherited.

TABLE 1
Derivation of chroma prediction mode from luma mode
when sps_cclm_enabled_flag is true

| Chroma | Corresponding luma intra prediction mode | | | | |
|---|---|---|---|---|---|
| prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2.

TABLE 2
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2, the first bin indicates whether it is regular (0) or LM modes (1). If it is LM mode, then the next bin indicates whether it is LM_LA (0) or not. If it is not LM_LA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 2 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples. Three MMLM model modes (MMLM_LT, MMLM_T, and MMLM_L) are allowed for choosing the neighbouring samples from left-side and above-side, above-side only, and left-side only, respectively.

FIG. 3 shows an example of classifying the neighbouring samples into two groups. Threshold is calculated as the average value of the neighbouring reconstructed luma samples. A neighbouring sample with Rec′_{L}[x,y]<=Threshold is classified into group 1; while a neighbouring sample with Rec′_{L}[x,y]>Threshold is classified into group 2.

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 8 )$$

Accordingly, the MMLM uses two models according to the sample level of the neighbouring samples.

### Slope Adjustment of CCLM

CCLM uses a model with 2 parameters to map luma values to chroma values as shown in FIG. 4A. The slope parameter “a” and the bias parameter “b” define the mapping as follows:

$$chromaVal = a * lumaVal + b$$

An adjustment “u” to the slope parameter is signalled to update the model to the following form, as shown in FIG. 4B:

$$chromaVal = {a}^{′} * lumaVal + {b}^{′}$$

where

$$\begin{matrix}{a}^{′} = a + u , \\ {b}^{′} = b - u * {y}_{r} .\end{matrix}$$

With this selection, the mapping function is tilted or rotated around the point with luminance value yᵣ. The average of the reference luma samples used in the model creation as yᵣ in order to provide a meaningful modification to the model. FIGS. 4A and 4B illustrate the process.

### Implementation of Slope Adjustment of CCLM

Slope adjustment parameter is provided as an integer between −4 and 4, inclusive, and signalled in the bitstream. The unit of the slope adjustment parameter is (⅛)-th of a chroma sample value per luma sample value (for 10-bit content).

Adjustment is available for the CCLM models that are using reference samples both above and left of the block (e.g. “LM_CHROMA_IDX” and “MMLM_CHROMA_IDX”), but not for the “single side” modes. This selection is based on coding efficiency versus complexity trade-off considerations. “LM_CHROMA_IDX” and “MMLM_CHROMA_IDX” refers to CCLM_LT and MMLM_LT in this invention. The “single side” modes refer to CCLM_L, CCLM_T, MMLM_L, and MMLM_T in this invention.

When slope adjustment is applied for a multi-model CCLM mode, both models can be adjusted and thus up to two slope updates are signalled for a single chroma block.

### Encoder Approach for Slope Adjustment of CCLM

The proposed encoder approach performs an SATD (Sum of Absolute Transformed Differences) based search for the best value of the slope update for Cr and a similar SATD based search for Cb. If either one results as a non-zero slope adjustment parameter, the combined slope adjustment pair (SATD based update for Cr, SATD based update for Cb) is included in the list of RD (Rate-Distortion) checks for the TU.

### Convolutional Cross-Component Model (CCCM)—Single Model and Multi-Model

In CCCM, a convolutional model is applied to improve the chroma prediction performance. The convolutional model has 7-tap filter consisting of a 5-tap plus sign shape spatial component, a nonlinear term and a bias term. The input to the spatial 5-tap component of the filter consists of a centre (C) luma sample which is collocated with the chroma sample to be predicted and its above/north (N), below/south(S), left/west (W) and right/east (E) neighbours as shown in FIG. 5.

The nonlinear term (denoted as P) is represented as power of two of the centre luma sample C and scaled to the sample value range of the content:

$$P = ( C * C + midVal ) ≫ bitDepth .$$

For example, for 10-bit contents, the nonlinear term is calculated as:

$$P = ( C * C + 512 ) ≫ 10$$

The bias term (denoted as B) represents a scalar offset between the input and output (similarly to the offset term in CCLM) and is set to the middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

The filter coefficients cᵢ are calculated by minimising MSE between predicted and reconstructed chroma samples in the reference area. FIG. 6 illustrates an example of the reference area which consists of 6 lines of chroma samples above and left of the PU. Reference area extends one PU width to the right and one PU height below the PU boundaries. Area is adjusted to include only available samples. The extensions to the area (indicated as “paddings”) are needed to support the “side samples” of the plus-shaped spatial filter in FIG. 5 and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

For signalling, when the CCLM mode is enabled for the current CU, two flags are signalled separately for Cb and Cr components to indicate whether GLM is enabled for each component. If the GLM is enabled for one component, one syntax element is further signalled to select one of 16 gradient filters (710-740 in FIG. 7) for the gradient calculation. The GLM can be combined with the existing CCLM by signalling one extra flag in bitstream. When such combination is applied, the filter coefficients that are used to derive the input luma samples of the linear model are calculated as the combination of the selected gradient filter of the GLM and the down-sampling filter of the CCLM.

### Spatial Candidate Derivation

The derivation of spatial merge candidates in VVC is the same as that in HEVC except that the positions of first two merge candidates are swapped. A maximum of four merge candidates for current CU 810 are selected among candidates located in the positions depicted in FIG. 8. The order of derivation is B₀, A₀, B₁, A₁ and B₂. Position B₂ is considered only when one or more neighbouring CU of positions B₀, A₀, B₁, A₁ are not available (e.g., belonging to another slice or tile) or is intra coded. After candidate at position A₁ is added, the addition of the remaining candidates is subject to a redundancy check which ensures that candidates with the same motion information are excluded from the list so that coding efficiency is improved. To reduce computational complexity, not all possible candidate pairs are considered in the mentioned redundancy check. Instead, only the pairs linked with an arrow in FIG. 9 are considered and a candidate is only added to the list if the corresponding candidate used for redundancy check does not have the same motion information.

### Temporal Candidates Derivation

In this step, only one candidate is added to the list. Particularly, in the derivation of this temporal merge candidate for a current CU 1010, a scaled motion vector is derived based on the co-located CU 1020 belonging to the collocated reference picture as shown in FIG. 10A. The reference picture list and the reference index to be used for the derivation of the co-located CU is explicitly signalled in the slice header. The scaled motion vector 1030 for the temporal merge candidate is obtained as illustrated by the dotted line in FIG. 10A, which is scaled from the motion vector 1040 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 10B. If CU at position C₀ is not available, is intra coded, or is outside of the current row of CTUs, position C₁ is used. Otherwise, position C₀ is used in the derivation of the temporal merge candidate.

### Non-Adjacent Spatial Candidate

During the development of the VVC standard, a coding tool referred as Non-Adjacent Motion Vector Prediction (NAMVP) has been proposed in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399). According to the NAMVP technique, the non-adjacent spatial merge candidates are inserted after the TMVP (i.e., the temporal MVP) in the regular merge candidate list. The pattern of spatial merge candidates is shown in FIG. 11. The distances between non-adjacent spatial candidates and current coding block are based on the width and height of current coding block. In FIG. 11, each small square corresponds to a NAMVP candidate and the candidates are ordered (as shown by the number inside the square) according to the distance. The line buffer restriction is not applied. In other words, the NAMVP candidates far away from a current block may have to be stored that may require a large buffer.

Adaptive Reordering of Merge Candidates with Template Matching (ARMC-TM)

The merge candidates are adaptively reordered with Template Matching (TM). The reordering method is applied to regular merge mode, TM merge mode, and affine merge mode (excluding the SbTMVP candidate). For the TM merge mode, merge candidates are reordered before the refinement process.

An initial merge candidate list is firstly constructed according to given checking order, such as spatial, TMVPs, non-adjacent, HMVPs, pairwise, virtual merge candidates. Then, the candidates in the initial list are divided into several subgroups. For the template matching (TM) merge mode, adaptive DMVR mode, each merge candidate in the initial list is firstly refined by using TM/multi-pass DMVR. Merge candidates in each subgroup are reordered to generate a reordered merge candidate list and the reordering is according to cost values based on template matching. The index of selected merge candidate in the reordered merge candidate list is signalled to the decoder. For simplification, merge candidates in the last, but not the first subgroup, are not reordered. All the zero candidates from the ARMC reordering process are excluded during the construction of merge motion vector candidate list. The subgroup size is set to 5 for regular merge mode and TM merge mode. The subgroup size is set to 3 for affine merge mode.

### ARMC-TM: Cost Calculation

The template matching cost of a merge candidate during the reordering process is measured by the SAD between samples of a template of the current block and their corresponding reference samples. The template comprises a set of reconstructed samples neighbouring to the current block. Reference samples of the template are located by the motion information of the merge candidate. When a merge candidate utilizes bi-directional prediction, the reference samples of the template of the merge candidate are also generated by bi-prediction as shown in FIG. 12.

In FIG. 12, block 1212 corresponds to a current block in current picture 1210, blocks 1222 and 1232 correspond to reference blocks in reference pictures 1220 and 1230 in list 0 and list 1 respectively. Templates 1214 and 1216 are for current block 1212, templates 1224 and 1226 are for reference block 1222, and templates 1234 and 1236 are for reference block 1232. Motion vectors 1240, 1242 and 1244 are the list 0 motion vector of the merge candidate and motion vectors 1250, 1252 and 1254 are the list 1 motion vector of the merge candidate.

### ARMC-TM: Refinement of the Initial Merge Candidate List

When multi-pass DMVR is used to derive the refined motion to the initial merge candidate list, only the first pass (i.e., PU level) of multi-pass DMVR is applied in reordering. When template matching is used to derive the refined motion, the template size is set equal to 1. Only the above or left template is used during the motion refinement of TM when the block is flat with block width greater than 2 times of height or narrow with height greater than 2 times of width. TM is extended to perform 1/16-pel MVD precision. The first four merge candidates are reordered with the refined motion in TM merge mode.

For subblock-based merge candidates with subblock size equal to Wsub× Hsub, the above template comprises several sub-templates with the size of Wsub×1, and the left template comprises several sub-templates with the size of 1×Hsub. As shown in FIG. 13, the motion information of the subblocks in the first row and the first column of current block is used to derive the reference samples of each sub-template. In FIG. 13, block 1312 corresponds to a current block in current picture 1310 and block 1322 corresponds to a collocated block in reference picture 1320. Each small square in the current block and the collocated block corresponds to a subblock. The dot-filled areas on the left and top of the current block correspond to template for the current block. The boundary subblocks are labelled from A to G. The arrow associated with each subblock corresponds to the motion vector of the subblock. The reference subblocks (labelled as Aref to Gref) are located according to the motion vectors associated with the boundary subblocks. The dot-filled areas on the left and top of the reference subblocks (i.e., Aref to Gref) correspond to template of the reference subblocks.

### ARMC-TM: Reordering Criteria

In the reordering process, a candidate is considered as redundant if the cost difference between a candidate and its predecessor is small than a lambda value, such as |D1−D2|<λ, where D1 and D2 are the costs obtained during the first ARMC ordering and λ is the Lagrangian parameter used in the RD criterion at encoder side.

The proposed algorithm is defined as the following:
Determine the minimum cost difference between a candidate and its predecessor among all candidates in the list
   If the minimum cost difference is larger than or equal to λ, the list is considered diverse enough and the reordering stops.
   If this minimum cost difference is smaller than λ, the candidate is considered as redundant, and it is moved at a further position in the list. This further position is the first position where the candidate is diverse enough compared to its predecessor (i.e., the cost difference between the candidate and its predecessor is larger than 2).
The algorithm stops after a finite number of iterations (if the minimum cost difference is not inferior to λ).

This algorithm is applied to the regular, TM, BM and affine merge modes. A similar algorithm is applied to the merge MMVD and MVD sign prediction methods which also use ARMC for the reordering.

The value of λ is set equal to the λ of the rate distortion criterion used to select the best merge candidate at the encoder side for low delay configuration and to the value λ corresponding to another QP for Random Access configuration. A set of λ values corresponding to each signalled QP offset is provided in the SPS or in the Slice Header for the QP offsets which are not present in the SPS.

### ARMC-TM: Extension to AMVP Modes

The ARMC design is also applicable to the AMVP mode wherein the AMVP candidates are reordered according to the TM cost. For the template matching for advanced motion vector prediction (TM-AMVP) mode, an initial AMVP candidate list is constructed, followed by a refinement from TM to construct a refined AMVP candidate list. In addition, an MVP candidate with a TM cost larger than a threshold, which is equal to five times of the cost of the first MVP candidate, is skipped.

Note, when wrap around motion compensation is enabled, the MV candidate shall be clipped with wrap around offset taken into consideration.

### MV Candidate Type Based ARMC

Merge candidates of one single candidate type, e.g., TMVP or non-adjacent MVP (NA-MVP), are reordered based on the ARMC TM cost values. The reordered candidates are then added into the merge candidate list. The TMVP candidate type adds more TMVP candidates with more temporal positions and different inter prediction directions to perform the reordering and the selection. Moreover, NA-MVP candidate type is further extended with more spatially non-adjacent positions. The target reference picture of the TMVP candidate can be selected from any one of reference picture in the list according to scaling factor. The selected reference picture is the one whose scaling factor is the closest to 1.

In the present invention, methods and apparatus to improve the performance or to reduce the complexity of the cross-component prediction tools with candidate reordering are disclosed.

### BRIEF SUMMARY OF THE INVENTION

A method and apparatus for candidate reordering are disclosed. According to this method, input data associated with a current block comprising a first-colour block and a second-colour block are received, wherein the input data comprise pixel data to be encoded at an encoder side or data associated with the current block to be decoded at a decoder side. Cross-component prediction candidates are determined. The cross-component prediction candidates are reordered into reordered cross-component prediction candidates, wherein said reordering the cross-component prediction candidates is constrained depending on one or more conditions. A cross-component prediction candidate list is derived by inserting one or more target candidates from the reordered cross-component prediction candidates. The second-colour block is encoded or decoded using prediction data comprising cross-colour prediction generated by applying one of said one or more target candidates to reconstructed first-colour block.

In one embodiment, said one or more conditions comprise a size or area of the current block. For example, said one or more conditions are determined by comparing the size, width or height of the current block with a threshold.

In one embodiment, the cross-component prediction candidates are categorized into candidate groups and said one or more conditions comprise the candidate groups. In one embodiment, the reordered cross-component prediction candidates are generated by comparing first candidates from the candidate groups respectively. In one embodiment, the cross-component prediction candidates are categorized into the candidate groups according to partial or all model parameters associated with the cross-component model modes of the cross-component prediction candidates.

In one embodiment, for each of the candidate groups, the cross-component prediction candidates associated with said each of the candidate groups are reordered into a reordered preparatory list based on template costs associated with the cross-component prediction candidates in said each of the candidate groups. In one embodiment, the reordered preparatory list consists of N1 candidates and N2 candidates of the reordered preparatory list with smallest template costs are inserted into the cross-component prediction candidate list, and N1 and N2 are positive integers and N2 is smaller than or equal to N1.

In one embodiment, the candidate groups correspond to different sources of the cross-component prediction candidates. In one embodiment, the different sources of the cross-component prediction candidates comprise spatial candidates, temporal candidates, non-adjacent neighbour candidates, historical candidates or a combination thereof.

In one embodiment, the candidate groups correspond to different cross-component model modes of the cross-component prediction candidates. In one embodiment, the different cross-component model modes of the cross-component prediction candidates comprise CCLM, MMLM, CCCM, CCCM multi-model or a combination thereof.

In one embodiment, when the cross-component prediction candidates are categorized into different types and said one or more conditions comprise the different types, and wherein only partial types of the different types are allowed to be reordered separately before the cross-component prediction candidates are added into the cross-component prediction candidate list.

In one embodiment, a number of comparison operations associated with said reordering the cross-component prediction candidates is constrained to be no greater than a maximum allowed number of comparison operations. In one embodiment, a number of model error computation operations associated with said reordering the cross-component prediction candidates is constrained when said reordering the cross-component prediction candidates is based on model errors associated with the cross-component prediction candidates.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 shows an example of the location of the left and above samples and the sample of the current block involved in the LM_LA mode.

FIG. 3 shows an example of classifying the neighbouring samples into two groups according to multiple mode CCLM.

FIG. 4A illustrates an example of the CCLM model.

FIG. 4B illustrates an example of the effect of the slope adjustment parameter “u” for model update.

FIG. 5 illustrates an example of spatial part of the convolutional filter.

FIG. 6 illustrates an example of reference area with paddings used to derive the filter coefficients.

FIG. 7 illustrates the 16 gradient patterns for Gradient Linear Model (GLM).

FIG. 8 illustrates the neighbouring blocks used for deriving spatial merge candidates for VVC.

FIG. 9 illustrates the possible candidate pairs considered for redundancy check in VVC.

FIG. 10A illustrates an example of temporal candidate derivation, where a scaled motion vector is derived according to POC (Picture Order Count) distances.

FIG. 10B illustrates the position for the temporal candidate selected between candidates C₀ and C₁.

FIG. 11 illustrates an exemplary pattern of the non-adjacent spatial merge candidates.

FIG. 12 illustrates an example of templates used for the current block and corresponding reference blocks to measure matching costs associated with merge candidates.

FIG. 13 illustrates the template and reference samples of the template for block with sub-block motion using the motion information of the subblocks of the current block

FIG. 14 illustrates examples of CCM information propagation, where the blocks with dash line (i.e., A, E, G) are coded in cross-component mode (e.g., CCLM, MMLM, GLM, CCCM).

FIG. 15 illustrates an example of inheriting temporal neighbouring model parameters.

FIG. 16 illustrates an example of inheriting model parameters from the block at positions of the previous coded slices/picture.

FIG. 17 illustrates another example of inheriting model parameters from the block at positions of the previous coded slices/picture.

FIGS. 18A-B illustrate more examples of inheriting model parameters from the block at positions of the previous coded slices/picture.

FIGS. 19A-B illustrate two search patterns for inheriting non-adjacent spatial neighbouring models.

FIG. 20 illustrates an example to map motion information for the to-be referenced positions in a non-available region to pre-defined positions, where the pre-defined positions are located at one line above the above-first CTU row.

FIG. 21 illustrates an example to map motion information for the to-be referenced positions in a non-available region to pre-defined positions, where the pre-defined positions are located at the bottom line of respective CTU rows.

FIG. 22 illustrates an example to map motion information for the to-be referenced positions in a non-available region to pre-defined positions, where the pre-defined positions are located at the bottom line or the centre line of respective CTU rows.

FIG. 23 illustrates an example to map motion information for the to-be referenced positions in a non-available region to pre-defined positions, where the pre-defined positions are located at the bottom line of respective CTU rows or one CTU row above the respective CTU rows.

FIG. 24 illustrates an example of neighbouring templates for calculating model error.

FIG. 25 illustrates an example according to one embodiment of the present invention, where for the reordered preparatory list for each type, N₂ candidates with the smallest costs are inserted into the final candidate list.

FIG. 26 illustrates an example similar to FIG. 25, however all candidates are considered as one group.

FIG. 27 illustrates an example according to one embodiment of the present invention, where the final candidate is further reordered.

FIG. 28 illustrates an example according to one embodiment, wherein the candidate list for some types are reordered and inserted into the final candidate list, and the candidate list for other types are not reordered and inserted into the final candidate list directly.

FIG. 29 illustrates an example of redundancy check, where candidates 1, 2 and 3 are similar and accordingly, candidate 2 and 3 are considered as redundant.

FIG. 30 illustrates an example of reordering groups by comparing the first candidate of each group.

FIG. 31 illustrates an example of candidate reordering with constraints on the number of reordering/comparison operations, where the maximum number corresponds to 3.

FIG. 32 illustrates another example of candidate reordering with constraints on the number of reordering/comparison operations, where the maximum number corresponds to 4.

FIG. 33 illustrates an example of the maximum allowed number of model error computation operations being constrained when the reordering rule is based the model error, where the number of model error computation operations is constrained to be 2.

FIG. 34 illustrates an example of the maximum allowed number of model error computation operations being constrained when the reordering rule is based the model error, where the number of model error computation operations is constrained to be 4.

FIG. 35 illustrates an example of inheriting candidates from neighbouring blocks, where the current block inherits the first two candidates in the inherited candidate list of the above neighbouring block and the first two candidates in the inherited candidate list of the left neighbouring block.

FIG. 36 illustrates a flowchart of an exemplary video coding system that incorporates cross-component candidates reordered with constraints according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve performance of cross-component prediction, methods and apparatus to reorder candidates according to types of the candidates are disclosed as follows. Also, methods and apparatus to reduce the complexity associated with candidate reordering are disclosed.

### Inherit Neighbouring Model Parameters for Refining the Cross-Component Model Parameters

The final scaling parameter of the current block is inherited from the neighbouring blocks and further refined by dA. Once the final scaling parameter is determined (e.g., the inherited scaling parameter is refined), the offset parameter (e.g., β in CCLM) is derived based on the inherited scaling parameter and the average value of neighbouring luma and chroma samples of the current block. For example, if the final scaling parameter is inherited from a selected neighbouring block, and the inherited scaling parameter is α′ₙₑᵢ, then the final scaling parameter is (α′ₙₑᵢ+dA). For yet another embodiment, the final scaling parameter is inherited from a historical list and further refined by dA. For example, the historical list records the most recent j entries of final scaling parameters from previous CCLM-coded blocks. Then, the final scaling parameter is inherited from one selected entry of the historical list, α′ₗᵢₛₜ, and the final scaling parameter is (α′ₗᵢₛₜ+dA). For yet another embodiment, the final scaling parameter is inherited from a historical list or the neighbouring blocks, but only the MSB (Most Significant Bit) part of the inherited scaling parameter is taken, and the LSB (Least Significant Bit) of the final scaling parameter is from dA. For yet another embodiment, the final scaling parameter is inherited from a historical list or the neighbouring blocks, but does not further refine by dA.

For yet another embodiment, after inheriting model parameters, the offset parameter can be further refined by dB. For example, if the final offset parameter is inherited from a selected neighbouring block, and the inherited offset parameter is B′ₙₑᵢ, then the final offset parameter is (β′ₙₑᵢ+dB). For still another embodiment, the final offset parameter is inherited from a historical list and further refined by dB. For example, the historical list records the most recent j entries of final scaling parameters from previous CCLM-coded blocks. Then, the final scaling parameter is inherited from one selected entry of the historical list, β′ₗᵢₛₜ, and the final scaling parameter is (β′ₗᵢₛₜ+dB). For yet another embodiment, the final offset parameter is inherited from a historical list or the neighbouring blocks, but is not further refined by dB.

For yet another embodiment, if the inherited neighbour block is coded with CCCM, the filter coefficients (ct) are inherited. The offset parameter (e.g., c₆×B or c₆ in CCCM) can be re-derived based on the inherited parameter and the average value of neighbouring corresponding position luma and chroma samples of the current block. For still another embodiment, only partial filter coefficients are inherited (e.g., only n out of 7 filter coefficients are inherited, where 1≤n<7), the rest filter coefficients are further re-derived using the neighbouring luma and chroma samples of the current block.

For still another embodiment, if the inherited candidate applies GLM gradient pattern to its luma reconstructed samples, the current block shall also inherit the GLM gradient pattern of the candidate and apply to the current luma reconstructed samples.

For still another embodiment, if the inherited neighbour block is coded with multiple cross-component models (e.g., MMLM, or CCCM with multi-model), the classification threshold is also inherited to classify the neighbouring samples of the current block into multiple groups, and the inherited multiple cross-component model parameters are further assigned to each group. For yet another embodiment, the classification threshold is the average value of the neighbouring reconstructed luma samples, and the inherited multiple cross-component model parameters are further assigned to each group. Similarly, once the final scaling parameter of each group is determined, the offset parameter of each group is re-derived based on the inherited scaling parameter and the average value of neighbouring luma and chroma samples of each group of the current block. For another example, if CCCM with multi-model is used, once the final coefficient parameter of each group is determined (e.g., c₀ to c₅ except for c₆ in CCCM), the offset parameter (e.g., c₆×B or c₆ in CCCM) of each group is re-derived based on the inherited coefficient parameter and the neighbouring luma and chroma samples of each group of the current block.

For still another embodiment, inheriting model parameters may depend on the colour component. For example, Cb and Cr components may inherit model parameters or model derivation method from the same candidate or different candidates. For yet another example, only one of colour components inherits model parameters, and the other colour component derives model parameters based on the inherited model derivation method (e.g., if the inherited candidate is coded by MMLM or CCCM, the current block also derives model parameters based on MMLM or CCCM using the current neighbouring reconstructed samples). For still another example, only one of colour components inherits model parameters, and the other colour component derives its model parameters using the current neighbouring reconstructed samples.

For still another example, if Cb and Cr components can inherit model parameters or model derivation method from different candidates. The inherited model of Cr can depend on the inherited model of Cb. For example, possible cases include but not limited to (1) if the inherited model of Cb is CCCM, the inherited model of Cr shall be CCCM; (2) if the inherit model of Cb is CCLM, the inherit model of Cr shall be CCLM; (3) if the inherited model of Cb is MMLM, the inherited model of Cr shall be MMLM; (4) if the inherited model of Cb is CCLM, the inherited model of Cr shall be CCLM or MMLM; (5) if the inherited model of Cb is MMLM, the inherited model of Cr shall be CCLM or MMLM; (6) if the inherited model of Cb is GLM, the inherited model of Cr shall be GLM.

For yet another embodiment, after decoding a block, the cross-component model (CCM) information of the current block is derived and stored for later reconstruction process of neighbouring blocks using inherited neighbouring model parameters. The CCM information mentioned in this disclosure includes but not limited to prediction mode (e.g., CCLM, MMLM, CCCM), GLM pattern index, model parameters, or classification threshold. For example, even the current block is coded by inter prediction, the cross-component model parameters of the current block can be derived by using the current luma and chroma reconstruction or prediction samples. Later, if another block is predicted by using inherited neighbours model parameters, it can inherit the model parameters from the current block. For another example, the current block is coded by cross-component prediction, the cross-component model parameters of the current block are re-derived by using the current luma and chroma reconstruction or prediction samples. For another example, the stored cross-component model can be CCCM, LM_LA (i.e., single model LM using both above and left neighbouring samples to derive model), or MMLM_LT (i.e., multi-model LM using both above and left neighbouring samples to derive model). For still example, even the current block is coded by non-cross-component intra prediction (e.g., DC, planar, intra angular modes, MIP, or ISP), the cross-component model parameters of the current block are derived by using the current luma and chroma reconstruction or prediction samples.

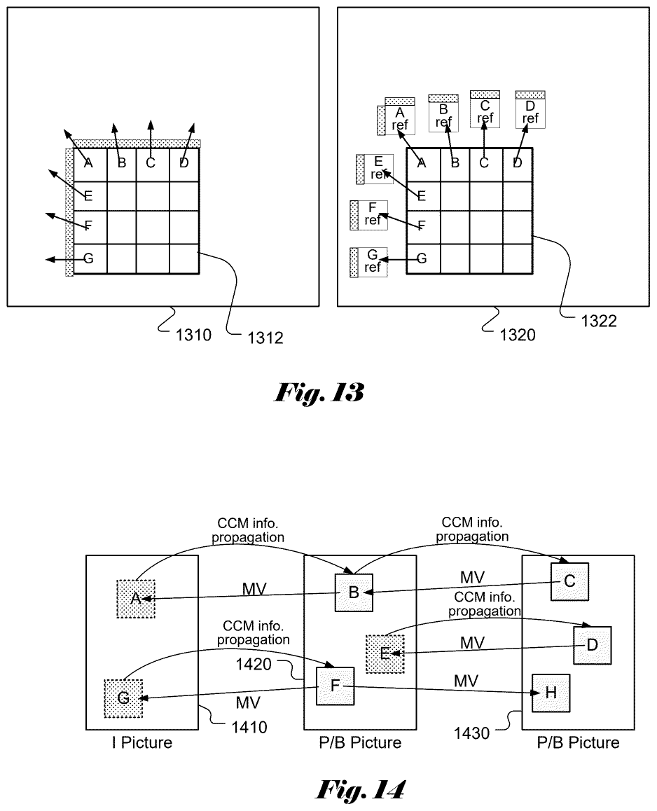

For still another example, when the current slice is a non-intra slice (e.g., P slice or B slice), a cross-component model of the current block is derived and stored for later reconstruction process of neighbouring blocks using inherited neighbouring model parameters. For still another embodiment, when the current block is inter-coded, the CCM information of the current inter-coded block is derived by copying the CCM information from its reference block that has CCM information in a reference picture, located by the motion information of the current inter-coded block. For example, as shown in the FIG. 14, the block B in a P/B picture 1420 is inter-coded, then the CCM information of block B is copied from its referenced block A in an I picture 1410 that has CCM information. For block D in the P/B picture 1430, it can copy the CCM information from a corresponding block E coded in intra. For still another embodiment, if the reference block in a reference picture is also inter-coded, the CCM information of the reference block is copied from the CCM information of another reference block in another reference picture. For example, as shown in the FIG. 14, the current block C in a current P/B picture 1430 is inter-coded and its referenced block B is also inter-coded, due to the CCM information of block B is copied from block A, then the CCM information of block A is also propagated to the current block C. For still another embodiment, when the current block is inter-coded with bi-directional prediction, if one of its reference blocks is intra-coded and has CCM information, the CCM information is copied from its intra-coded reference block in a reference picture. For example, suppose block F is inter-coded with bi-prediction and has reference blocks G and H. Block G is intra-coded and has CCM information. The CCM information of block F is copied from the block G coded in CCM mode. For still another embodiment, when the current block is inter-coded with bi-directional prediction, the CCM information of the current block is the combination of the CCM models of its reference blocks (as the method mentioned in section entitled: Inheriting multiple cross-component models).

### Inherit Spatial Neighbouring Model Parameters

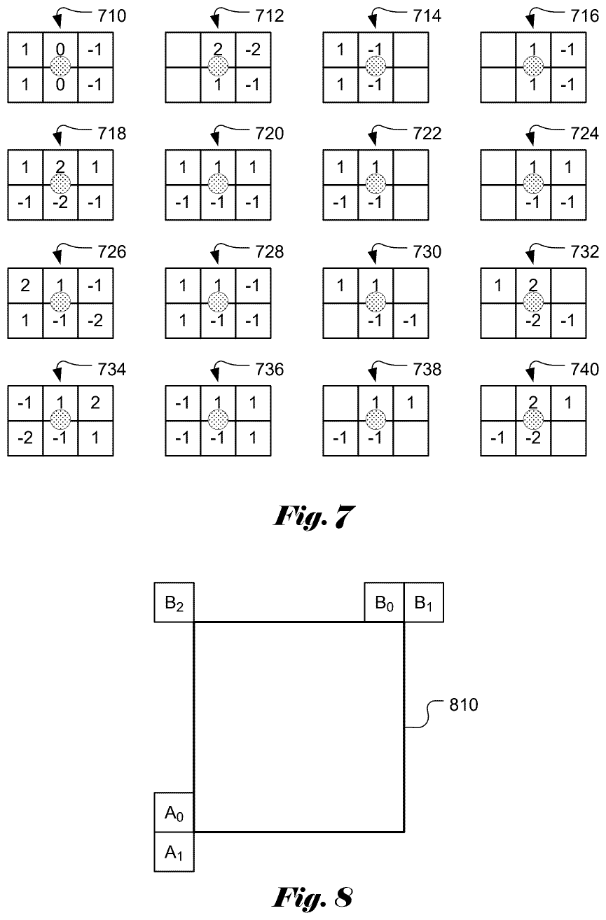

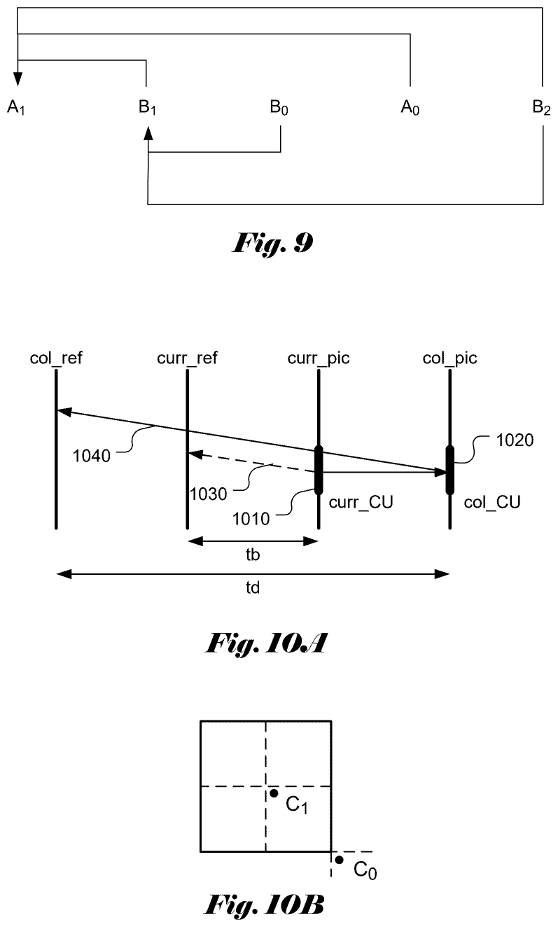

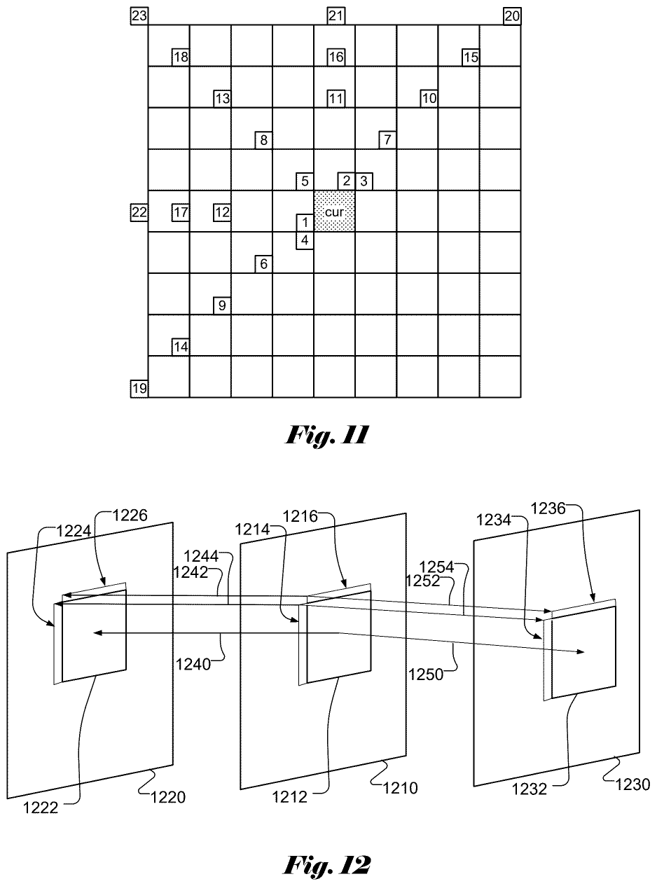

For another embodiment, the inherited model parameters can be from a block that is an immediate neighbouring block. The models from blocks at pre-defined positions are added into the candidate list in a pre-defined order. For example, the pre-defined positions can be the positions depicted in FIG. 8, and the pre-defined order can be B₀, A₀, B₁, A₁ and B₂, or A₀, B₀, B₁, A₁ and B₂. The block can be a chroma block or a single-tree luma block.

For still another embodiment, the pre-defined positions include the positions immediately above the centre position of the top line of the current block if W is greater than or equal to TH. Assume the position of the current chroma block is at (x,y), the pre-defined positions can be (x+(W>>1), y−1) or (x+ (W>>1)−1, y−1). The pre-defined positions also include the positions at the immediate left of the centre position of the left line of the current block if H is greater than or equal to TH. The pre-defined positions can be (x−1, (H>>1)) or (x−1, (H>>1)−1) position. W and H are the width and height of the current chroma block, and TH is a threshold value which can be 2, 4, 8, 16, 32, or 64.

For still another embodiment, the maximum number of inherited models from spatial neighbours are smaller than the number of pre-defined positions. For example, if the pre-defined positions are as depicted in FIG. 8, there are 5 pre-defined positions. If pre-defined order is B₀, A₀, B₁, A₁ and B₂, and the maximum number of inherited models from spatial neighbours is 4, the model from B₂ is added into the candidate list only when one of preceding blocks is not available or is not coded in cross-component model.

### Inheriting Temporal Neighbouring Model Parameters

For still another embodiment, if the current slice/picture is a non-intra slice/picture, the inherited model parameters can be from the block in the previous coded slices/pictures. For example, as shown in the FIG. 15, the current block position is at (x,y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy. In one embodiment, if the prediction mode of the current block is intra, Δx and Δy are set to 0. If the prediction mode of the current block is inter prediction, Δx and Δy are set to the horizontal and vertical motion vectors of the current block. In another embodiment, if the current block is inter bi-prediction, Δx and Δy are set to the horizontal and vertical motion vectors in reference picture list 0. In still another embodiment, if the current block is inter bi-prediction, Δx and Δy are set to the horizontal and vertical motion vectors in reference picture list 1.

For still another embodiment, if the current block is inter bi-prediction, the inherited model parameters can be from the block in the previous coded slices/pictures in the reference lists. For example, if the horizontal and vertical parts of the motion vector in reference picture list 0 are Δx_{L0} and Δy_{L0}, the motion vector can be scaled to other reference pictures in the reference list 0 and 1. If the motion vector is scaled to the i^{th} reference picture in the reference list 0 as (Δx_{L0,i0}, Δy_{L0,i0}). The model can be from the block in the i^{th} reference picture in the reference list 0, and Δx and Δy are set to (Δx_{L0,i0}, Δy_{L0,i0}). For another example, if the horizontal and vertical parts of the motion vector in reference picture list 0 are Δx_{L0} and Δy_{L0}, the motion vector is scaled to the i^{th} reference picture in the reference list 1 as (Δx_{L0,i1}, Δy_{L0,i1}). The model can be from the block in the i^{th} reference picture in the reference list 1, and Δx and Δy are set to (Δx_{L0,i1},Δy_{L0,i1}).

In one embodiment, if the current slice/picture is a non-intra slice/picture, the inherited model parameters can be from the block in the previous coded slices/pictures. In one embodiment, the current block position is at (x,y) and the block size is w×h. The two value sets αₓ and α_{y} are defined as:

$$\begin{matrix}{α}_{x} = \{ {α}_{x 1} , {α}_{x 2} , {α}_{x 3} , … , {α}_{xn} \} , {α}_{xi} < {α}_{xj} if i < j , \\ {α}_{y} = \{ {α}_{y 1} , {α}_{y 2} , {α}_{y 3} , … , {α}_{yn} \} , {α}_{yi} < {α}_{yj} if i < j .\end{matrix}$$

All values in αₓ and α_{y} are positive numbers. Let

$$( {x}_{mid} , {y}_{mid} ) = ( x + \frac{w}{2} , y + \frac{h}{2} ) .$$

The inherited model parameters can be from the block at positions (x_{mid}+αₓᵢ×w, y_{mid}+α_{yi}×h), (x_{mid}+αₓᵢ×w, y_{mid}−α_{yi}×h), (x_{mid}−αₓᵢ×w, y_{mid}+α_{yi}×h), (x_{mid}−αₓᵢ×w, y_{mid}−α_{yi}×h), (x_{mid}+αₓᵢ×w, y_{mid}), (x_{mid}−αₓᵢ×w, y_{mid}), (x_{mid}, y_{mid}+α_{yi}×h), (x_{mid}, y_{mid}−α_{yi}×h) of the previous coded slices/picture.

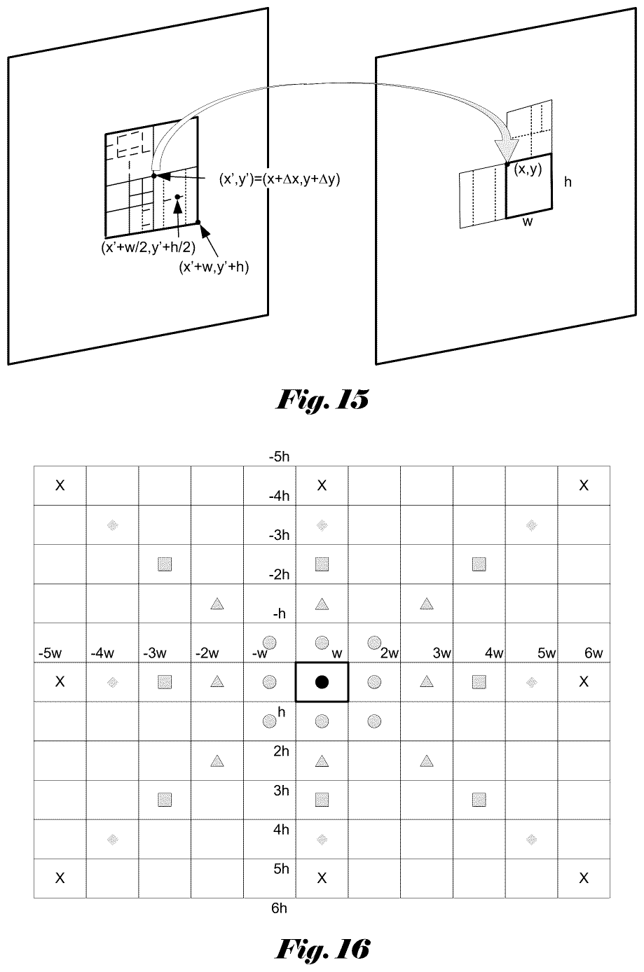

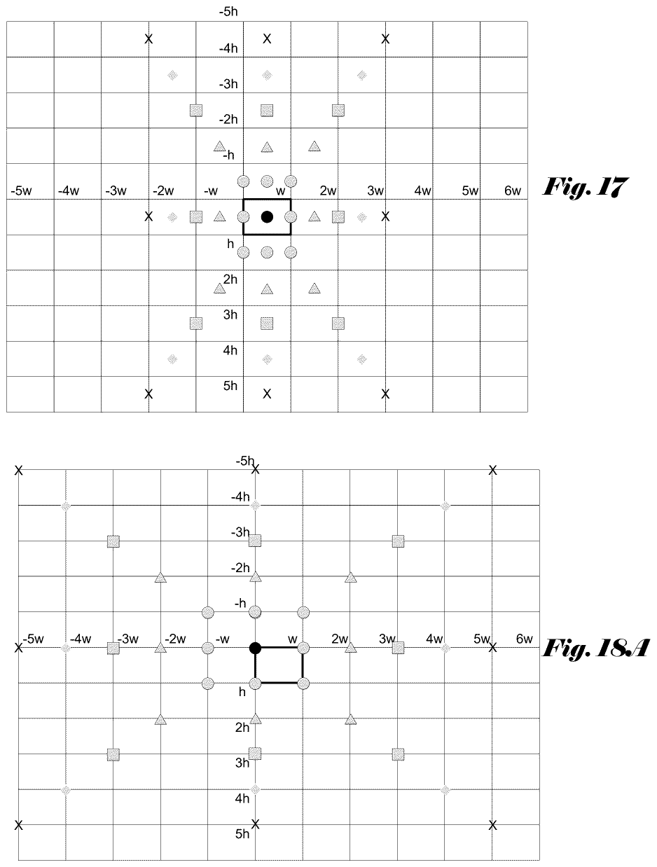

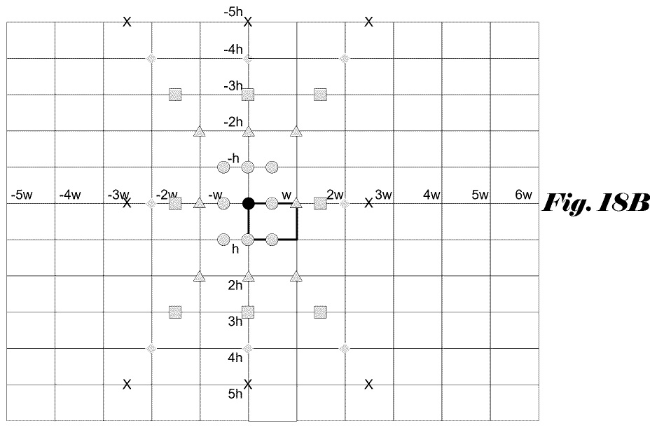

In one sub-embodiment, αₓ=α_{y}. For example, αₓ=α_{y}={1, 2, 3, 4, 5}. The inherited model parameters can be from the block at positions of the previous coded slices/picture depicted in FIG. 16. In FIG. 16, the current block is indicated by a thick-lined box and the location

$$( {x}_{mid} , {y}_{mid} ) = ( x + \frac{w}{2} , y + \frac{h}{2} )$$

of the current block is indicated by a black dot in the centre. The positions of the previous coded slices/picture are indicated by “X”, grey diamonds, grey squares, grey triangles and grey circles.

In another sub-embodiment, αₓ≠α_{y}. For example,

$${α}_{x} = \{ \frac{1}{2} , 1 , \frac{3}{2} , 2 , \frac{5}{2} \}$$

and α_{y}={1, 2, 3, 4, 5}. The inherited model parameters can be from the block at positions of the previous coded slices/picture depicted in FIG. 17.

In another embodiment, the current block position is at (x,y) (i.e., the upper left corner of the current block) and the block size is w×h. The inherited model parameters can be from the block at positions (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{y}; ×h), (x+αₓᵢ×w, y), (x−αₓᵢ×w, y), (x, y+α_{y}; ×h), (x, y−α_{yi}×h) of the previous coded slices/picture.

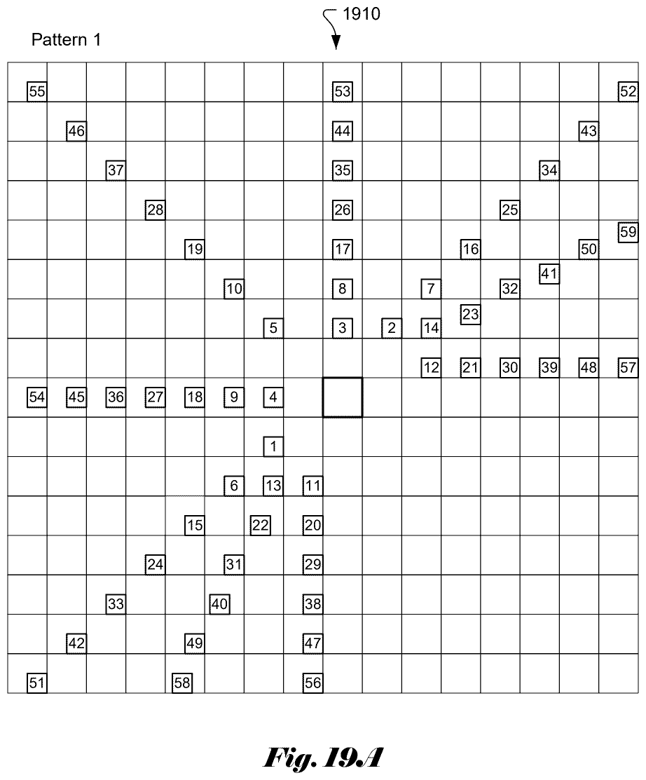

In one sub-embodiment, αₓ=α_{y}. For example, αₓ=α_{y}={1, 2, 3, 4, 5}. The inherited model parameters can be from the block at positions of the previous coded slices/picture depicted in FIG. 18A.

In another sub-embodiment, αₓ+α_{y}. For example,

$${α}_{x} = \{ \frac{1}{2} , 1 , \frac{3}{2} , 2 , \frac{5}{2} \}$$

and α_{y}={1, 2, 3, 4, 5}. The inherited model parameters can be from the block at positions of the previous coded slices/picture depicted in FIG. 18B.

In one embodiment, the models from the positions closer to (x_{mid}, y_{mid}) are added into the final merge candidate list first. In another embodiment, the models from the positions closer to (x,y) are added into the final merge candidate list first.

In one embodiment, let δx and δy be two fixed positive numbers. The inherited model parameters can be from the block at positions (x_{mid}+αₓᵢ×δx, y_{mid}+α_{yi}×δy), (x_{mid}+αₓᵢ×δx, y_{mid}−α_{yi}×δy), (x_{mid}−αₓᵢ×δx, y_{mid}+α_{yi}×δy), (x_{mid}−αₓᵢ×δx, y_{mid}−α_{yi}×δy), (x_{mid}+αₓᵢ×δx, y_{mid}), (x_{mid}−αₓᵢ×δx, y_{mid}), (x_{mid}, y_{mid}+α_{yi}×δy), (x_{mid}, y_{mid}−α_{yi}×δy) of the previous coded slices/picture.

In another embodiment, the current block position is at (x,y) and the block size is w×h. Let δx and δy be two fixed positive numbers The inherited model parameters can be from the block at positions (x+αₓᵢ×δx, y+α_{y}; ×δy), (x+αₓᵢ×δx, y−α_{yi}×δy), (x−αₓᵢ×δx, y+α_{yi}×δy), (x−αₓᵢ×δx, y−α_{yi}×δy), (x+αₓᵢ×δx, y), (x−αₓᵢ×δx, y), (x, y+α_{yi}×δy), (x, y−α_{yi}×δy) of the previous coded slices/picture.

In another embodiment, the current block position is at (x,y) and the block size is w×h. The inherited model parameters can be from the block at some pre-defined positions (x′, y′) of the previous coded slices/picture. For one example, the positions are inside the corresponding area of the current encoding block, i.e., x≤x′<x+w and y≤y′<y+h. The inherited model parameters can be from the block at (x,y), (x+w−1, y), (x, y+h−1), (x+w−1, y+h−1), (x+w/2, y+h/2). For another example, the positions are outside of the corresponding area of the current encoding block, i.e., x′<x+ or x′≥x+w, and y′<y or y′≥y+h. The inherited model parameters can be from the block at (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h), (x+w, y+h).

In one embodiment, the previous coded picture the inherited parameter model is from (i.e., the collocated picture) is one of the pictures in the reference lists.

In one embodiment, the collocated picture is signalled in the picture/slice header. The reference list and the reference index are signalled in the picture/slice header. For example, the collocated picture is selected as L0[0]. For another example, the collocated picture is selected as L1[0].

In one embodiment, the collocated picture is selected as the picture in the reference lists whose POC difference between the respective picture and the current picture is the smallest. For example, if the POC of current picture is 8, the POCs of pictures in reference list 0 are {7, 6, 5, 0} and POCs of pictures in reference list 1 are {7, 6, 5, 4}, then L0[0] (equivalent to L1 [0]) is selected since its POC difference is the smallest. In another sub-embodiment, if there are two pictures whose POC difference between the respective picture and the current picture are both the smallest, the picture with the smaller POC is selected. For example, if the POC of current picture is 2, the POCs of pictures in reference list 0 are {0, 4, 8} and POCs of pictures in reference list 1 are {8, 16, 32}, then L0[0] (POC=0) is selected. In another sub-embodiment, if there are two pictures whose POC difference between the respective picture and the current picture are both the smallest, the picture with the larger POC is selected. For example, if the POC of current picture is 2, the POCs of pictures in reference list 0 are {0, 4, 8} and POCs of pictures in reference list 1 are {8, 16, 32}, then L0[1] (POC=4) is selected. In another sub-embodiment, if there are two pictures whose POC difference between the respective picture and the current picture are both the smallest, the picture with smaller QP difference between the respective picture and the current picture is selected. For example, if the POC of current picture is 2, and the QP of current picture is 28. The POCs and QPs of the pictures in reference list 0 are {0, 4, 8} and {19, 26, 23}. The POCs and QPs of the pictures in reference list 1 are {8, 16, 32} and {23, 22, 21}. Then L0[1] (POC=4 and QP=26) is selected.

In one embodiment, the collocated picture is selected as the picture in the reference lists whose QP difference between the respective picture and the current picture is the smallest. For example, if the QP of current picture is 28, and the QPs of the pictures in reference list 0 are {19, 26, 23} and the QPs of the pictures in reference list 1 are {23, 22, 21}. Then L0[1] is selected. In another sub-embodiment, if there are more than one pictures in the reference lists whose QP difference between the respective picture and the current picture are the smallest, the picture with the smaller QP is selected. In another sub-embodiment, if there are more than one pictures whose QP difference between the respective picture and the current picture are the smallest, the picture with the larger QP is selected. In another sub-embodiment, if there are more than one pictures whose QP difference between the respective picture and the current picture are the smallest, the picture with the smaller POC distance is selected.

In one embodiment, the previous coded picture which the inherited parameter model is from (i.e., the collocated picture) is the most recently coded I-picture. The cross-component model information of the most recently coded I-slice/picture is stored in a long-term reference buffer.

In one embodiment, the collocated picture and the position where the inherited parameter model is from is determined by the motion vector of a neighbouring block. For example, if the current block position is at (x,y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the collocated picture, where x′=x+Δx and y′=y+Δy. Δx and Δy are set to the horizontal and vertical parts of the L0 motion vector of the neighbouring block respectively, and the collocated picture is the L0 reference picture indicated by the L0 motion vector of the neighbouring block. In still another embodiment, if the neighbouring block is inter bi-prediction, Δx and Δy are set to the horizontal and vertical parts of the L1 motion vector of the neighbouring block respectively, and the collocated picture is the L1 reference picture indicated by the L1 motion vector of the neighbouring block. In one embodiment, the neighbouring block is the left block of the current block. In another embodiment, the neighbouring block is the above block of the current block.

In one embodiment, the inherited model parameters are derived by using the luma and chroma reconstruction samples of the collocated block. Let the current block position be at (x,y) and the block size is w×h. The collocated block is a block positioned at (x′, y′) in the collocated picture with block size w×h, when the inherited model is from position (x′, y′). For example, the collocated block can be at (x,y). For another example, if Δx and Δy are the L0 horizontal and vertical parts of the motion vector of the neighbouring block respectively, and the collocated picture is the L0 reference picture indicated by the L0 motion vector of the neighbouring block, the collocated block can be at (x+Δx, y+Δy) in the collocated picture.

To limit the requirement buffer/storage resource, the available range for including temporal spatial candidates should be constrained. In one embodiment, only the cross-component model (CCM) information of the collocated picture in the CTU whose position in the collocated picture corresponds to the position of the current encoding CTU in the current picture can be referenced by temporal candidates. In another embodiment, only the CCM information of the collocated picture in the CTUs whose positions in the collocated picture correspond to the position of current encoding or left and right M CTUs in current picture can be referenced by temporal candidates, where M can be any integer greater than 0. In another embodiment, only the CCM information of the collocated picture in the CTUs whose positions in the collocated picture correspond to the position of current encoding or left M₁ and right M₂ CTUs in current picture can be referenced by temporal candidates, where M₁ and M₂ can be any integer greater than or equal to 0. In another embodiment, only the CCM information of the collocated picture in the CTU row whose position in collocated picture corresponds to the position of current encoding CTU row in current picture can be referenced by temporal candidates. In another embodiment, only the positions in collocated picture correspond to current CTU row or the above and below N CTU rows of the current picture can be referenced, where N can be any integer greater than 0. In another embodiment, only the positions in collocated picture correspond to current CTU row or the above N₁ and below N₂ CTU rows of the current picture can be referenced, where N₁ and N₂ can be any integer greater than 0. Note, the CCM information mentioned in this disclosure includes but not limited to prediction mode (e.g., CCLM, MMLM, CCCM), GLM pattern index, model parameters, or classification threshold.

### Inherit Non-Adjacent Spatial Neighbouring Models

For another embodiment, the inherited model parameters can be from blocks that are non-adjacent spatial neighbouring blocks. The models from blocks at pre-defined positions are added into the candidate list in a pre-defined order. For example, the positions and the order can be as depicted in FIG. 11. Each small square represents a candidate position and the number inside the square indicates the pre-defined order. The distances between each position and the current block are based on the width and height of the current coding block. For another embodiment, the distances between the positions that are closer to the current encoding block are smaller than the distances between the positions that are further away from the current block.

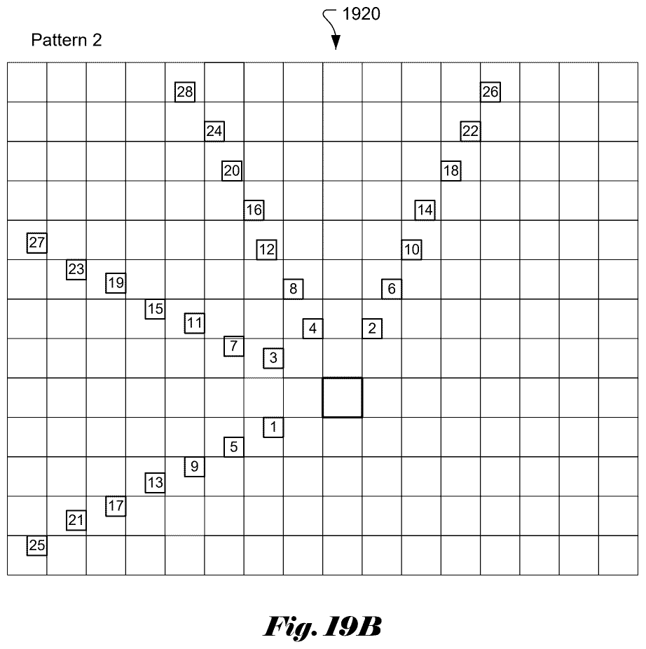

For still another embodiment, the maximum number of inherited models from non-adjacent spatial neighbours that can be added into the candidate list is smaller than the number of pre-defined positions. For example, the pre-defined positions are as depicted in FIGS. 19A-B, where two patterns (1910 and 1920) are shown. If the maximum number of inherited models from non-adjacent spatial neighbours that can be added into the candidate list is N, the models from positions in pattern 2 (1920) in FIG. 19B are added into the candidate list only when the number of available cross-component models from positions in pattern 1 (1910) in FIG. 19A is smaller than N.

### The Available Region of Non-Adjacent Spatial Candidates

To limit the requirement buffer/storage resource, the available range for including non-adjacent spatial candidates should be constrained. In one embodiment, only the cross-component model (CCM) information in the current CTU can be referenced by the non-adjacent spatial candidate. In another embodiment, only the CCM information in the current CTU or left M CTUs can be referenced by the non-adjacent spatial candidate. M can be any integer larger than 0. In another embodiment, only the CCM information in the current CTU row can be referenced by the non-adjacent spatial candidate. In another embodiment, only the to-be referenced position within the current CTU row or above N CTU rows can be referenced. N can be any integer larger than 0. If N is 0, this available region becomes the current CTU row only. Note, the CCM information mentioned in this disclosure includes but not limited to prediction mode (e.g., CCLM, MMLM, CCCM), GLM pattern index, model parameters, or classification threshold.

In another embodiment, the CCM information in the current CTU, the current CTU row, the current CTU row+above N CTU rows, the current CTU+left M CTUs, or the current CTU+above N CTU rows+left M CTUs can be referenced without limits (i.e., unconstrained). Furthermore, the CCM information in other regions can only be referenced by a larger pre-defined unit. For example, the CCM information in the current CTU row is stored within a 4×4 grid, and for other CCM information outside the current CTU row is stored within a 16×16 grid. In other words, one 16×16 region only needs to store one CCM information, so the to-be referenced position shall be rounded to the 16×16 grid, or changed to the nearest position of 16×16 grid.

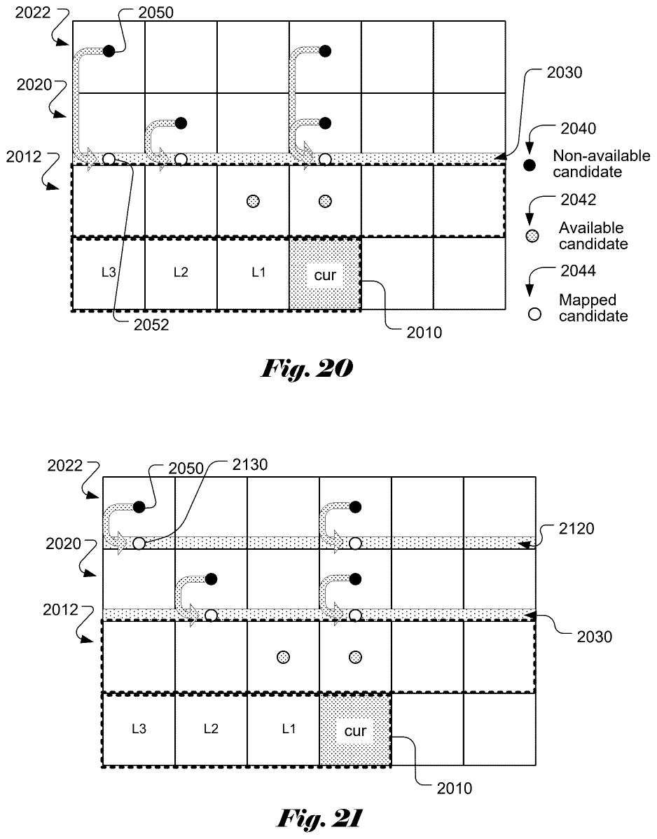

In another embodiment, the CCM information in the current CTU row, or the current CTU row+M CTU rows can be referenced without limits (i.e., unconstrained), and for the to-be referenced positions in the above CTU rows, the positions will be mapped to one line above of current CTU, or the current CTU row+M CTU rows for referencing. This design can preserve most of the coding efficiency and doesn't increase buffer by much for storing the CCM information of above CTU rows. For example, the CCM information in the current CTU row (2010) and the first CTU row above (2012) can be referenced without limits; and for the to-be referenced positions in the above-second (2020), above-third (2022), above-fourth CTU row, and so on, the positions will be mapped to one line (2030) above the above-first CTU row (as shown in FIG. 20). In FIG. 20, a dark circle indicates a non-available candidate 2040, a dot-filled circle indicates an available candidate 2042, and an empty circle indicates a mapped candidate 2044. For example, the non-available candidate 2050 in the above-second (2022) CTU row is mapped to a mapped candidate 2052 in one line (2030) above the above-first CTU row (2012).

In the above example, the region that can be referenced without limits is close to the current CTU (e.g., the current CTU row or the above-first CTU row). However, the region according to the present invention is not limited to the exemplary region shown above. The region can be larger or smaller than the example shown above. In general, the region can be limited to be within one or more pre-defined distances in a vertical direction, a horizontal direction or both from the current CTU. In the above example, the region is limited to 1 CTU height in the above vertical direction, which can be extended to 2 or 3 CTU heights if desired. In the case that left M CTUs are used, the limit is M CTU width for the current CTU row. The horizontal position of a to-be referenced position and the horizontal position of a mapped pre-defined position can be the same (e.g., position 2050 and position 2052 in the same horizontal position). However, other horizontal position may also be used.

In another embodiment, the CCM information in the current CTU row, or the current CTU row+M CTU rows can be referenced without limits. Furthermore, for the to-be referenced positions in the above CTU rows, the positions will be mapped to the last line of the corresponding CTU row for referencing. For example, as shown in FIG. 21, the CCM information in the current CTU row (2010) and the first CTU row (2012) above can be referenced without limits, and for the to-be referenced positions in the above-second CTU row (2020), the positions will be mapped to the bottom line (2030) of the above-second CTU row (2020). For the to-be referenced positions in above third CTU row (2022), the positions will be mapped to the bottom line (2120) of the above-third CTU row (2022). For example, the non-available candidate 2050 in the above-third CTU row (2022) is mapped to a mapped candidate 2130 in the bottom line (2120) of the above-third CTU row (2022). The legend for the candidate types (i.e., 2040, 2042 and 2044) of FIG. 21 is the same as that in FIG. 20. In this example, the unconstrained region may include one or more above CTU rows (e.g., 1 CTU row in FIG. 21). The above-second CTU row is above the unconstrained region. The above-third CTU row is also referred as an above-above CTU row since it is above the CTU row (i.e., the above-second CTU row) above the unconstrained region.

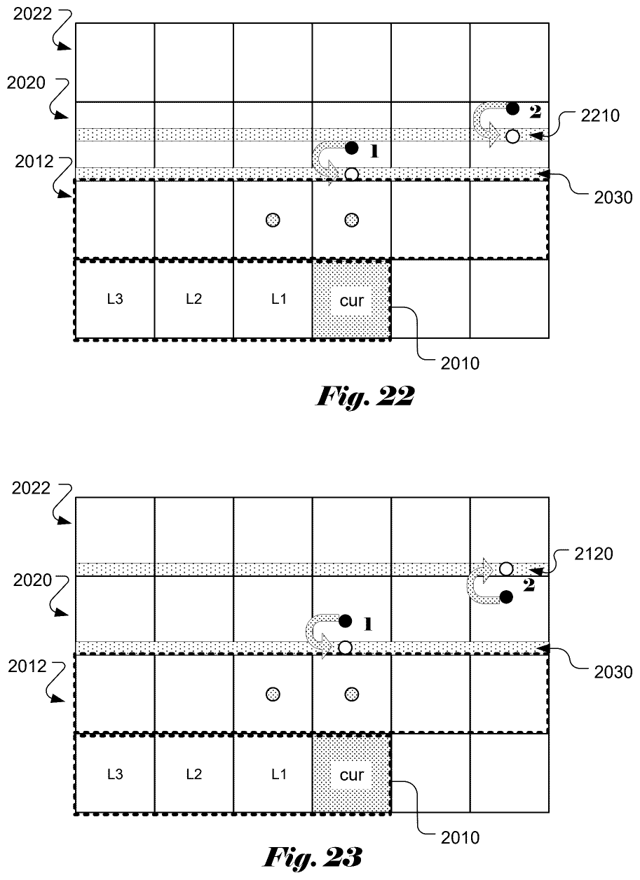

In another embodiment, the CCM information in the current CTU row, or the current CTU row+M CTU rows can be referenced without limits, and for the to-be referenced positions in above CTU rows, the positions will be mapped to the last line or bottom line or centre line of the corresponding CTU row for referencing depending on the position of the to-be referenced CCM information. For example, as shown in FIG. 22, the CCM information in the current CTU row (2010) and the above-first CTU row (2012) can be referenced without limits, and for the to-be referenced position 1 in above-second CTU row (2020), the positions will be mapped to the bottom line (2030) of the above-second CTU row before referring. However, for the to-be referenced position 2 in above-second CTU row, the positions will be mapped to the centre line (2210) of the above-second CTU row (2020) before referring since it is in the top half region of the above-second CTU row (2020) and hence it is closer to the centre line (2210) compared with bottom line (2030). The legend for the candidate types (i.e., 2040, 2042 and 2044) of FIG. 22 is the same as that in FIG. 20.

In another embodiment, the CCM information in the current CTU row, or the current CTU row+M CTU rows can be referenced without limits, and for the to-be referenced positions in the above CTU rows, the positions will be mapped to the last line or bottom line of the corresponding CTU row for referencing depending on the position of the to-be referenced CCM information. For example, as shown in FIG. 23, the CCM information in the current CTU row (2010) and the above-first CTU row (2012) can be referenced without limits, and for the to-be referenced position 1 in the above-second CTU row (2020), the positions will be mapped to the bottom line (2030) of the above-second CTU row (2020) before referring. However, for the to-be referenced position 2 in the above-second CTU row (2020), the positions will be mapped to the bottom line (2120) of the above-third CTU row (2022) before referring since it is closer to the bottom line (2120) of the above-third CTU row compared with bottom line (2030) of the above-second CTU row as shown in FIG. 23. The legend for the candidate types (i.e., 2040, 2042 and 2044) is the same as that in FIG. 20.

In another embodiment, the CCM information in the current CTU, or the current CTU+N left CTU can be referenced without limits, and for the left CTUs, the to-be referenced positions will be mapped to the very right line closest to the current CTU, or the current CTU+N left CTU. For example, the CCM information in the current CTU and first left CTU can be referenced without limits, and if the to-be referenced positions are in the second left CTU, the positions will be mapped to one line left to the first left CTU. If the to-be referenced positions are in the third left CTU, the positions will be mapped to one line left to first left CTU.

In yet another embodiment, the CCM information in the current CTU and the first left CTU can be referenced without limits, and if the to-be referenced positions are in the second left CTU, the positions will be mapped to the very right line (i.e., the rightmost line) of the second left CTU. If the to-be referenced positions are in the third left CTU, the positions will be mapped to the very right line to the third left CTU.

In another embodiment, when the available range for including non-adjacent candidates is constrained, if the position of a non-adjacent candidate is outside of the available range, that candidate is skipped and will not be inserted into the candidate list. The available region can be the current CTU, current CTU row, current CTU row+above N CTU rows, current CTU+left M CTUs, or current CTU+above N CTU rows+left M CTUs.

### Models Generated Based on Other Inherited Models

In another embodiment, a single cross-component model can be generated from a multiple cross-component model. The single cross-component model can then be added into the candidate list.

In one embodiment, after inherited candidates (e.g., spatial neighbour candidates, temporal neighbour candidates, non-adjacent neighbour candidates or history candidates) are added in the candidate list, if there exist candidates coded with multiple cross-component models (e.g., MMLM, CCCM with multi-model, or other CCCM variants with multi-model), a single cross-component model can be generated based on the existing multiple cross-component models. As described in “Multiple Model CCLM (MMLM)” and “Convolutional cross-component model (CCCM)-single model and multi-model”, let the model used for samples in group 1 be denoted as model 1 and the model used for samples in group 2 be denoted as model 2, a single cross-component model (e.g., CCLM or CCCM) can be generated by selecting model 1 or model 2.

In one embodiment, both model 1 and model 2 are added into the candidate list. In another embodiment, only model 1 is added into the candidate list. For another example, only model 2 is added into the candidate list.

For another example, if a candidate is coded with multiple cross-component models (e.g., MMLM, or CCCM with multi-model), a single cross-component model can be generated by selecting the first or the second cross-component model in the multi cross-component models.

### Candidate List Construction

In one embodiment, the candidate list is constructed by adding candidates in a pre-defined order until the maximum candidate number is reached. The candidates added may include all or some of the aforementioned candidates, but not limited to the aforementioned candidates. For example, the candidate list may include spatial neighbouring candidates, temporal neighbouring candidate, historical candidates, non-adjacent neighbouring candidates, single model candidates generated based on other inherited models (as mentioned in section entitled: Models generated based on other inherited models) or combined model (as mentioned later in section entitled: Inheriting multiple cross-component models). For another example, the candidate list includes the same candidates as previous example, but the candidates are added into the list in a different order.

In another embodiment, if all the pre-defined neighbouring and historical candidates are added but the maximum candidate number is not reached, some default candidates are added into the candidate list until the maximum candidate number is reached.

In one sub-embodiment, the default candidates include but not limited to the candidates described below. The default candidates are CCLM models: pred_{C}(i,j)=α·rec_{L}′(i,j)+β. The final scaling parameter a is from the set {0,⅛,−⅛,+2/8,−2/8,+⅜,−⅜,+4/8,−4/8), and the offset parameter β=1/(1<<bit_depth) or is derived based on neighbouring luma and chroma samples. For example, if the average value of neighbouring luma and chroma samples are lumaAvg and chromaAvg, then β is derived by β=chromaAvg−α·lumaAvg. The average value of neighbouring luma samples (i.e., lumaAvg) can be calculated by all selected luma samples, the luma DC mode value of the current luma CB (Coding Block), or the average of the maximum and minimum luma samples

$$( e . g . , lumaAvg = ( Max ( {x}_{A}^{0} , {x}_{A}^{1} ) + Min ( {x}_{B}^{0} , {x}_{B}^{1} ) + 1 ) ≫ 1 , or lumaAvg = ( Min ( {x}_{A}^{0} , {x}_{A}^{1} ) + Max ( {x}_{B}^{0} , {x}_{B}^{1} ) + 1 ) ≫ 1 ) .$$

Similarly, average value of neighbouring chroma samples (i.e., chromaAvg) can be calculated by all selected chroma samples, the chroma DC mode value of the current chroma CB, or the average of the maximum and minimum chroma samples

$$( e . g . , chromaAvg = ( Max ( {y}_{A}^{0} , {y}_{A}^{1} ) + Min ( {y}_{B}^{0} , {y}_{B}^{1} ) + 1 ) ≫ 1 , or lumaAvg = ( Min ( {y}_{A}^{0} , {y}_{A}^{1} ) + Max ( {y}_{B}^{0} , {y}_{B}^{1} ) + 1 ) ≫ 1 ) .$$

In another sub-embodiment, the default candidates include but not limited to the candidates described below. The default candidates are two-parameter GLM models: α·G+β, where G is the luma sample gradients instead of down-sampled luma samples L. The 16 GLM filters described in the section, entitled “Gradient Linear Model (GLM)”, are applied. The final scaling parameter a is from the set {0,⅛,−⅛,+2/8,−2/8,+⅜,−⅜,+4/8,−4/8). The offset parameter β=1/(1<<bit_depth) or is derived based on neighbouring luma and chroma samples.

In another embodiment, a default candidate can be derived based on an earlier candidate in the candidate list with a delta scaling parameter refinement. For example, if the scaling parameter of an earlier candidate is α, the scaling parameter of a default candidate is (α+Δα), where Δα can be ⅛, −⅛, +2/8, −2/8, +⅜,−⅜, +4/8, −4/8. And the offset parameter of a default candidate would be derived by (α+Δα) and the average value of neighbouring luma and chroma samples of the current block.

In another embodiment, a default candidate can be a shortcut to indicate a cross-component mode (i.e., using the current neighbouring luma/chroma reconstruction samples to derive cross-component models) rather than inheriting parameters from neighbours. For example, default candidate can be CCLM_LT, CCLM_L, CCLM_T, MMLM_LT, MMLM_L, MMLM_T, single model CCCM, multiple models CCCM or cross-component model with a specified GLM pattern.

In another embodiment, a default candidate can be a cross-component mode (i.e., using the current neighbouring luma/chroma reconstruction samples to derive cross-component models) rather than inheriting parameters from neighbours, and also with a scaling parameter update (Aa). Then, the scaling parameter of a default candidate is (a+Aa). For example, default candidate could be CCLM_LT, CCLM_L, CCLM_T, MMLM_LT, MMLM_L, or MMLM_T. For another example, Aa can be ⅛,−⅛, +2/8, −2/8, +⅜,−⅜, +4/8, −4/8. And the offset parameter of a default candidate can be derived by (α+Δα) and the average value of neighbouring luma and chroma samples of the current block. For still another example, the Δα can be different for each colour components.

In another embodiment, a default candidate can be an earlier candidate with partial selected model parameters. For example, suppose an earlier candidate has m parameters, it can choose k out of m parameters from the earlier candidate to be a default candidate, where 0<k<m and m>1.

In another embodiment, a default candidate can be the first model of an earlier MMLM candidate (i.e., the model used when the sample value is less than or equal to the classification threshold). In still another embodiment, a default candidate can be the second model of an earlier MMLM candidate (i.e., the model used when the sample value is greater than or equal to the classification threshold). In still another embodiment, a default candidate can be the combination of two models of an earlier MMLM candidate. For example, if the models of an earlier MMLM candidate are

$$\{ {c}_{0}^{0} , {c}_{1}^{0} , … , {c}_{M - 1}^{0} \} and \{ {c}_{0}^{1} , {c}_{1}^{1} , … , {c}_{M - 1}^{1} \} .$$

The model parameters of an default candidate can be

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which can be predefined or implicitly derived according to neighbouring template cost, and

$${c}_{x}^{y}$$

is the x-th parameter of the y-th model.

### Removing or Modifying Similar Neighbouring Model Parameters

When inheriting cross-component model parameters from other blocks, it can further check the similarity between the inherited model and the existing models in the candidate list or those model candidates derived by the neighbouring reconstructed samples of the current block (e.g., models derived by CCLM, MMLM, or CCCM using the neighbouring reconstructed samples of the current block). If the model of a candidate is similar to the existing models, the model will not be included in the candidate list. In one embodiment, it can compare the similarity of (α×lumaAvg+β) or a among existing candidates to decide whether to include the model of a candidate or not. For example, if the (α×lumaAvg+β) or a of the candidate is the same as one of the existing candidates, the model of the candidate is not included. For another example, if the difference of (α×lumaAvg+β) or a between the candidate and one of existing candidates is less than a threshold, the model of the candidate is not included. Besides, the threshold can be adaptive based on coding information (e.g., the current block size or area). For another example, when comparing the similarity, if the model of a candidate and the existing model both use CCCM, it can compare similarity by checking the value of (c₀C+c₁N+c₂S+c₃E+c₄W+c₅P+c₆B) to decide whether to include the model of a candidate or not. In another embodiment, if the position of a candidate is located in the same CU as one of the existing candidates, the model of the candidate is not included. In still another embodiment, if the model of a candidate is similar to one of existing candidate models, it can adjust the inherited model parameters so that the inherited model is different from the existing candidate models. For example, if the inherited scaling parameter is similar to one of existing candidate models, the inherited scaling parameter can add a predefined offset (e.g., 1>>S or −(1>>S), where S is the shift parameter) so that the inherited parameter is different from the existing candidate models.

### Reordering the Candidates in the List

The candidates in the list can be reordered to reduce the syntax overhead when signalling the selected candidate index. The reordering rules can depend on the coding information of neighbouring blocks or the model error. For example, if neighbouring above or left blocks are coded by MMLM, the MMLM candidates in the list can be moved to the head of the current list. Similarly, if neighbouring above or left blocks are coded by single model LM or CCCM, the single model LM or CCCM candidates in the list can be moved to the head of the current list. Similarly, if GLM is used by neighbouring above or left blocks, the GLM related candidates in the list can be moved to the head of the current list.

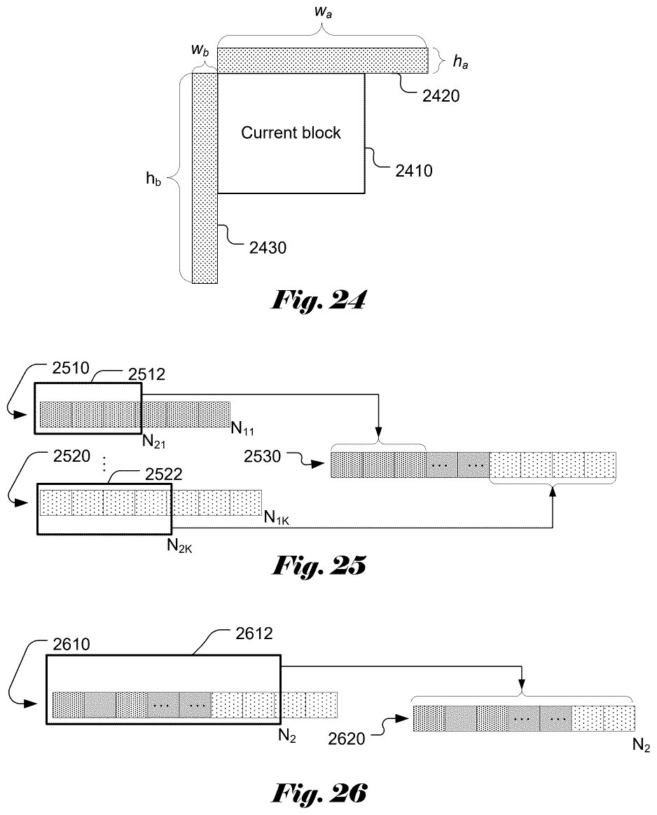

In still another embodiment, the reordering rule is based on the model error by applying the candidate model to the neighbouring templates of the current block, and then compare the error with the reconstructed samples of the neighbouring template. For example, as shown in FIG. 24, the size of above neighbouring template 2420 of the current block is wₐ×hₐ, and the size of left neighbouring template 2430 of the current block 2410 is wₚ×hₚ. Suppose K models are in the current candidate list, and αₖ and βₖ are the final scaling and offset parameters after inheriting the candidate k. The model error of candidate k corresponding to the above neighbouring template is:

$${e}_{a}^{k} = {\sum }_{i , j} \vert ( {α}_{k} \times {recL}_{a}^{′ ( i , j )} + {β}_{k} ) - {recC}_{a}^{( i , j )} \vert$$

where,

$${recL}_{a}^{′ ( i , j )} and {recC}_{a}^{( i , j )}$$

are the reconstructed samples of luma (e.g., after downsampling process or after applying GLM pattern) and reconstructed samples of chroma at position (i,j) in the above template, and 0≤i<wₐ and 0≤j<hₐ.

Similarly, the model error of candidate k by the left neighbouring template is:

$${e}_{b}^{k} = {\sum }_{m , n} \vert ( {α}_{k} \times {recL}_{b}^{′ ( m , n )} + {β}_{k} ) - {recC}_{b}^{( m , n )} \vert$$

where

$${recL}_{b}^{′ ( m , n )} and {recC}_{b}^{( m , n )}$$

are the reconstructed samples of luma (e.g., after applying downsampling process or GLM pattern) and reconstructed samples of chroma at position (m, n) in the left template, and 0≤m<w_{b} and 0≤n<h_{b}.

Then the model error of candidate k is:

$${e}^{k} = {e}_{a}^{k} + {e}_{b}^{k}$$

After calculating the model error among all candidates, it can get a model error list E={e⁰, e¹, e², . . . , e^{k}, . . . , e^{K}}. Then, it can reorder the candidate index in the inherited candidate list by sorting the model error list in ascending order.

In still another embodiment, if the candidate k uses CCCM prediction, the

$${e}_{a}^{k} and {e}_{b}^{k}$$

are defined as:

$$\begin{matrix}{e}_{a}^{k} = {\sum }_{i , j} \vert ( c {0}_{k} \times {recL}_{a}^{′ ( i , j )} + c {1}_{k} \times {recL}_{a}^{′ ( i , j - 1 )} + c {2}_{k} \times {recL}_{a}^{′ ( i , j + 1 )} + c {3}_{k} \times {recL}_{a}^{′ ( i - 1 , j )} + c {4}_{k} \times {recL}_{a}^{′ ( i + 1 , j )} + c {5}_{k} \times P + c {6}_{k} \times B ) - {recC}_{a}^{( i , j )} \vert \\ {e}_{b}^{k} = {\sum }_{i , j} \vert ( c {0}_{k} \times {recL}_{b}^{′ ( i , j )} + c {1}_{k} \times {recL}_{b}^{′ ( i , j - 1 )} + c {2}_{k} \times {recL}_{b}^{′ ( i , j + 1 )} + c {3}_{k} \times {recL}_{b}^{′ ( i - 1 , j )} + c {4}_{k} \times {recL}_{b}^{′ ( i + 1 , j )} + c {5}_{k} \times P + c {6}_{k} \times B ) - {recC}_{b}^{( i , j )} \vert\end{matrix}$$

where c0ₖ, c1ₖ, c2ₖ, c3ₖ, c4ₖ, c5ₖ, and cox are the final filtering coefficients after inheriting the candidate k. P and B are the nonlinear term and bias term.

In still another embodiment, if the above neighbouring template is not available, then

$${e}^{k} = {e}_{b}^{k} .$$

Similarly, if the left neighbouring template is not available, then

$${e}^{k} = {e}_{a}^{k} .$$

If both templates are not available, the candidate index reordering method using model error is not applied.

In still another embodiment, not all positions inside the above and left neighbouring template are used in calculating model error. It can choose partial positions inside the above and left neighbouring template to calculate model error. For example, it can define a first start position and a first subsampling interval depending on the width of the current block to partially select positions inside the above neighbouring template. Similarly, it can define a second start position and a second subsampling interval depending on the height of the current block to partially select positions inside the left neighbouring template.

In another embodiment, hₐ or w_{b} can be a constant value (e.g., hₐ or w_{b} can be 1, 2, 3, 4, 5, or 6). For another embodiment, hₐ or w_{b} can be dependent on the block size. If the current block size is greater than or equal to a threshold, hₐ or w_{b} is equal to a first value. Otherwise, hₐ or w_{b} is equal to a second value.

In still another embodiment, the candidates of different types are reordered separately before the candidates are added into the final candidate list. For each type of the candidates, the candidates are added into a preparatory candidate list with a pre-defined size N₁. The candidates in the preparatory list are reordered. The N₂ candidates with the smallest costs are then added into the final candidate list, where N₂≤N₁. FIG. 25 illustrates an example according to this embodiment, where there are K types. For the reordered preparatory list of type 1 (2510), N₂₁ candidates with the smallest costs (2512) among the total of N₁₁ candidates are in front of the list. For the reordered preparatory list of type K (2520), N_{2K} candidates with the smallest costs (2522) among the total of N_{1K} candidates are in front of the list. The final candidate list 2530 is formed by inserting the N₂ᵢ candidates (j=1, . . . , K) with the smallest costs from the K reordered preparatory lists. In another embodiment, the candidates are categorized into different types based on the source of the candidates, including but not limited to the spatial neighbouring models, temporal neighbouring models, non-adjacent spatial neighbouring models, and the historical candidates. In another embodiment, the candidates are categorized into different types based on the cross-component model mode. For example, the types can be CCLM, MMLM, CCCM, and CCCM multi-model. For another example, the types can be GLM-non active or GLM active.

In another embodiment, the candidates are all be categorized as the same type (i.e., the number of preparatory list is equal to 1 (K=1)). FIG. 26 illustrates an example according to this embodiment. For the reordered preparatory list (2610) with a pre-defined size N₁, N₂ candidates with the smallest costs (2612) among the total of N₁ candidates are in front of the list. The final candidate 2620 list is formed by inserting the N₂ candidates with the smallest costs from the reordered preparatory list. In another embodiment, the final candidate list is formed according to an embodiment of the present invention can be further reordered. For example, the final candidate list 2530 (FIG. 25) can be further reordered to form a reordered final list 2710 as shown in FIG. 27. Assuming the size of the final candidate list 2530 is N_{1final}. Only the candidates with the smallest N_{2final} costs can be selected (i.e., the inherited candidate index, as described in section entitled “Signalling the inherited candidate index in the list”, is smaller than N_{2final}). N_{2final}≤N_{1final}.

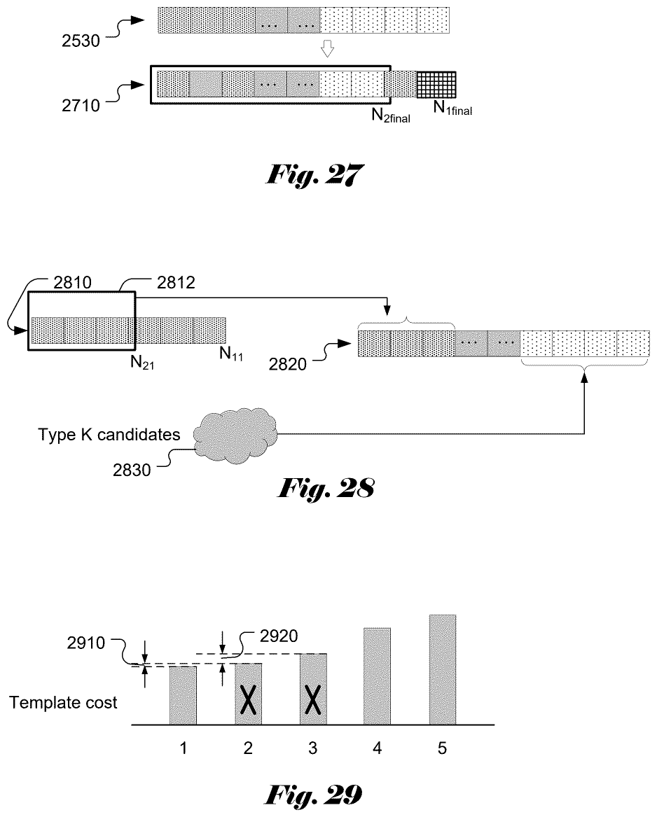

In another embodiment, only partial types of candidates are allowed to be reordered separately before the candidates are added into the final candidate list. For example, if the candidate types are categorized into spatial neighbouring models, temporal neighbouring models, non-adjacent spatial neighbouring models, and historical models, only one or more than one of the categories are reordered. For still the same example, only the temporal and non-adjacent spatial neighbouring models are reordered separately before the candidates are added into the final candidate list. FIG. 28 illustrates an example according to this embodiment, wherein the candidate list for type 1 (2810) is reordered and N₂₁ candidates with the smallest costs (2812) are inserted into the final list 2820. On the other hand, candidates from list for type K (K≠1) (2830) are inserted into the final list 2820 without reordering.

In still another embodiment, after the candidates are reordered based on the template cost, the redundancy of the candidate can be further checked. A candidate is considered to be redundant if the template cost difference between the candidate and its predecessor in the list is smaller than a threshold. If a candidate is considered redundant, it can be removed from the list, or it can be move to the end of the list. An example of redundancy check is illustrated in FIG. 29, where candidates 1, 2 and 3 are similar since the differences (2910 and 2920) are smaller than a threshold. Accordingly, candidate 2 and 3 are considered as redundant.

Although the reordering process could yield high coding gain, it could also significantly increase the decoding time if not executed properly. Accordingly, in still another embodiment, reordering of the candidates are only performed depending on the block size or area. For example, reordering of the candidates is only performed if the size of the current encoding block is greater than or equal to a pre-defined threshold. For another example, reordering of the candidates is only performed if the width of the current encoding block is greater than or equal to a pre-defined threshold. For another example, reordering of the candidates is only performed if the height of the current encoding block is greater than or equal to a pre-defined threshold. For another example, reordering of the candidates is only performed if the size of the current encoding block is less than or equal to a pre-defined threshold. For another example, reordering of the candidates is only performed if the width of the current encoding block is less than or equal to a pre-defined threshold. For another example, reordering of the candidates is only performed if the height of the current encoding block is less than or equal to a pre-defined threshold.

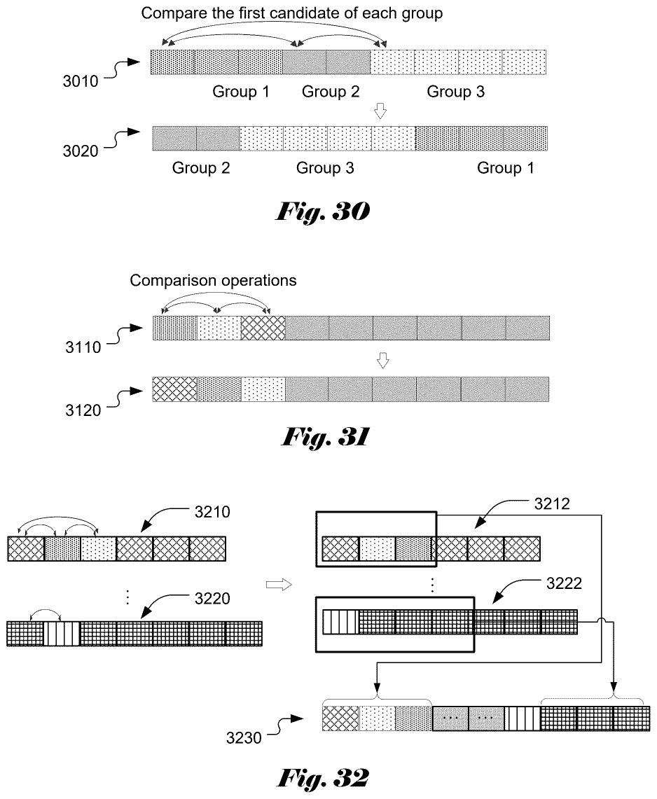

In another embodiment, the candidates are categorized into several groups. The candidates are reordered in unit of candidate group. The groups are reordered by comparing the first candidate of each group as shown in FIG. 30, wherein the first candidates among groups 1, 2 and 3 are compared (3010). A reordered final candidate list 3020 is formed by reordering the groups according to the comparison results (Group 2, Group 3 and then Group 1). In one embodiment, the candidates are grouped based on the source of the candidates, including but not limited to the spatial neighbouring models, temporal neighbouring models, non-adjacent spatial neighbouring models, and the historical candidates. In another embodiment, the candidates are grouped based on the cross-component model mode. For example, the groups can be CCLM, MMLM, CCCM, and CCCM multi-model. For another example, the groups can be GLM-non active or GLM active. In another embodiment, the candidates are grouped based on the value of partial or all model parameters. For example, the candidates are grouped based on the scaling factor α of the cross-component linear model and c₀ for CCCM. If the candidate is multi-model, such as MMLM or CCCM multi-model, the scaling factor α of the cross-component linear model and c₀ of the first model are used. Let I={I₁, I₂, I₃, . . . I_{N}} be an interval set. For a candidate, if its scaling factor value falls in the interval Iₙ, 1≤n≤N, then the candidate is in the n-th group. The interval set I can be {[αₘᵢₙ,αₘₑₐₙ), [αₘₑₐₙ,αₘₐₓ)}, where αₘᵢₙ and αₘₐₓ are the minimum and maximum value of scaling factor of all the candidates, and mean is the mean value of scaling factor of all the candidates. For another example, the interval set I can be {[αₘᵢₙ,αₘᵢₙ+δα), [αₘᵢₙ+δα, αₘᵢₙ+2δα), [αₘᵢₙ+2δα,αₘᵢₙ+3δα), [αₘᵢₙ+3δα,αₘᵢₙ+4δα)}, where δα=(αₘₐₓ−αₘᵢₙ)/4.

In another embodiment, the number of reordering operations, i.e., the maximum allowed number of comparison operations, is constrained. Hence only partial candidates are reordered. For example, only the first few candidates in the candidate list are reordered. If the number of comparison operations is constrained to 3, only the first three candidates in the candidate list are reordered as shown in FIG. 31. The three comparison operations are: comparing candidate 1 and 2, comparing candidate 1 and 3 and comparing candidate 2 and 3 in the list 3110 to form a reordered list 3120. For another example, if the candidates are grouped into spatial/temporal/non-adjacent neighbouring models and historical models, and the candidates are reordered separately before they are added into the final candidate list. The total number of comparison operations are constrained. For example, if the total number of comparison operations is constrained to 4, as shown in FIG. 32, only compare the 1st and 2nd candidates, and 2nd and 3rd candidates in spatial candidates (for list 3210), the 1st and 2nd candidates in temporal candidates (not shown in FIG. 32), and compare the 1st and 2nd candidates in non-adjacent candidates (for list 3220) to form the final candidate list 3230.

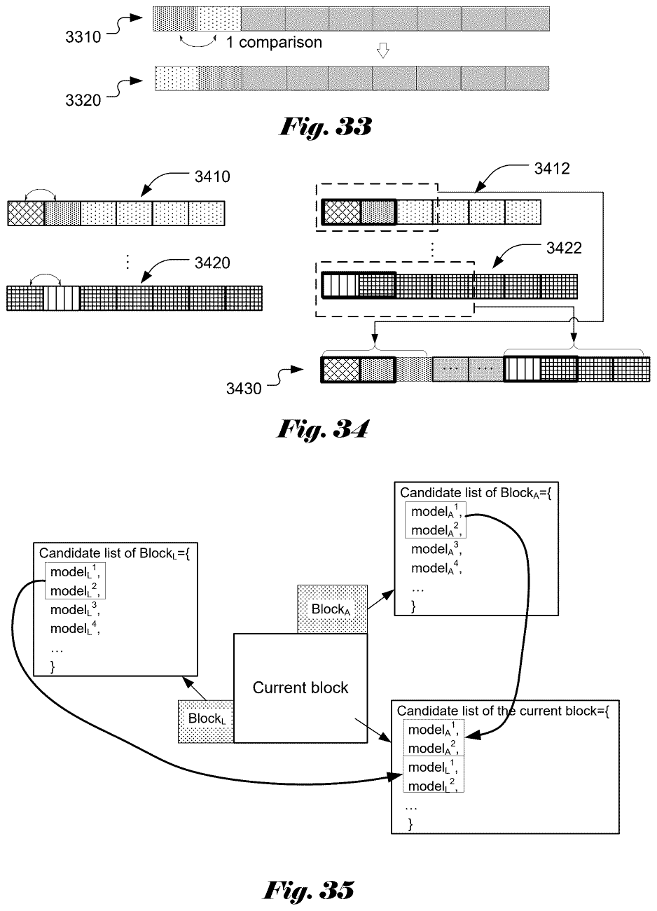

In another embodiment, the number of model error computation operations is constrained when the reordering rule is based the model error. Only partial candidates are reordered. For example, only the first few candidates in the candidate list are reordered. If the number of model error computation operations is constrained to 3, only the model errors of the first three candidates are computed. Hence only the first 3 candidates are reordered and totally 3 comparison operations are performed. For another example, if the number of model error computation operations is constrained to 4, only the model errors of the first 4 candidates are computed. Hence only the first 4 candidates are reordered and totally 6 comparison operations are performed. For another example, if the candidates are categorized into different groups, such as spatial/temporal/non-adjacent neighbouring models and historical models, and the candidates of each group are reordered separately before they are added into the final candidate list. The total number of model error computation operations are constrained. For example, if the total number of model error computation operations is constrained to 4, only the model error of the first 2 spatial candidates and the model error of the first 2 temporal candidates are computed. Hence only the first 2 spatial candidates and the first 2 temporal candidates are compared and reordered. Totally 2 comparison operations are performed (One between the two spatial candidates and one between the two temporal candidates). FIG. 33 illustrates an example, where the number of model error computation operations is constrained to 2, and only the model errors of the first two candidates are computed for list 3310 and hence only the first two candidates are compared to form a reordered list 3320. FIG. 34 illustrates another example, where the number of model error computation operations is constrained to 4. For the final list 3430, only the model errors of the first two candidates are computed for list 1 (3410) and hence only the first two candidates of list 1 are compared to form a reordered list 1 (3412). And the model errors of the first two candidates are computed for list K (3420) and hence the first two candidates of list K are compared to form a reordered list K (3422).

Inheriting Candidates from the Candidates in the Candidate List of Neighbours

The candidates in the current inherited candidate list can be from neighbouring blocks. For example, it can inherit the first k candidates in the inherited candidate list of the neighbouring blocks. As shown in the FIG. 35, the current block can inherit the first two candidates in the inherited candidate list of the above neighbouring block and the first two candidates in the inherited candidate list of the left neighbouring block. For an embodiment, after adding the neighbouring spatial candidates and non-adjacent spatial candidates, if the current inherited candidate list is not full, the candidates in the candidate list of neighbouring blocks are included into the current inherited candidate list. For another embodiment, when including the candidates in the candidate list of neighbouring blocks, the candidates in the candidate list of left neighbouring blocks are included before the candidates in the candidate list of above neighbouring blocks. For still another embodiment, when including the candidates in the candidate list of neighbouring blocks, the candidates in the candidate list of above neighbouring blocks are included before the candidates in the candidate list of left neighbouring blocks.

### Signalling the Inherited Candidate Index in the List

An on/off flag can be signalled to indicate if the current block inherits the cross-component model parameters from neighbouring blocks or not. The flag can be signalled per CU/CB, per PU, per TU/TB, or per colour component, or per chroma colour component. A high-level syntax can be signalled in SPS, PPS (Picture Parameter Set), PH (Picture header) or SH (Slice Header) to indicate if the proposed method is allowed for the current sequence, picture, or slice.

If the current block inherits the cross-component model parameters from neighbouring blocks, the inherited candidate index is signalled. The index can be signalled (e.g., signalled using truncate unary code, Exp-Golomb code, or fix length code) and shared among both the current Cb and Cr blocks. For another example, the index can be signalled per colour component. For example, one inherited candidate index is signalled for Cb component, and another inherited candidate index is signalled for Cr component. For another example, it can use chroma intra prediction syntax (e.g., IntraPredModeC [xCb][yCb]) to store the inherited candidate index.

If the current block inherits the cross-component model parameters from neighbouring blocks, the current chroma intra prediction mode (e.g., IntraPredModeC [xCb][yCb] as defined in VVC standard) is temporally set to a cross-component mode (e.g., CCLM_LT) at the bitstream syntax parsing stage. Later, at the prediction stage or reconstruction stage, the candidate list is derived, and the inherited candidate model is then determined by the inherited candidate index. After obtaining the inherited model, the coding information of the current block is then updated according to the inherited candidate model. The coding information of the current block includes but not limited to the prediction mode (e.g., CCLM_LT or MMLM_LT), related sub-mode flags (e.g., CCCM mode flag), prediction pattern (e.g., GLM pattern index), and the current model parameters. Then, the prediction of the current block is generated according to the updated coding information.

### Inheriting Multiple Cross-Component Models

The final prediction of the current block can be the combination of predictions of multiple cross-component models, or fusion of the prediction of selected cross-component models with the prediction by non-cross-component coding tools (e.g., intra angular prediction modes, intra planar/DC modes, or inter prediction modes). In one embodiment, if the current candidate list size is N, it can select k candidates from the total N candidates (where k≤N). Then, k predictions are respectively generated by applying the cross-component model of the selected k candidates using the corresponding luma reconstruction samples. The final prediction of the current block is the combination results of these k predictions. For example, if two candidate predictions (denoted as p_{cand1} and p_{cand2}) are combined, the final prediction at (x,y) position of the current block is p_{final}(x,y)=(1−α)×p_{cand1}(x,y)+α×p_{cand2}(x,y), where α is a weighting factor. Besides, the weighting factor α can be predefined or implicitly derived according to neighbouring template cost (i.e., model error). For example, by using the template cost defined in the section entitled: Reordering the candidates in the list, the corresponding template cost of two candidates are e^{cand1} and e^{cand2}, then α is e^{cand1}/(e^{cand1}+e^{cand2}). In another embodiment, if two candidate models are combined, the selected models are from the first two candidates in the list. In still another embodiment, if i candidate models are combined, the selected models are from the first i candidates in the list.

In another embodiment, if the current candidate list size is N, it can select k candidates from the total N candidates (where k≤N). The k cross-component models can be combined into one final cross-component model by weighted-averaging the corresponding model parameters. For example, if a cross-component model has M parameters, the j-th parameter of the final cross-component model is the weighted-averaging of the j-th parameter of the k selected candidates, where j is 1 . . . M. Then, the final prediction is generated by applying the final cross-component model to the corresponding luma reconstructed samples. For example, if two candidate models

$$\{ {c}_{0}^{0} , {c}_{1}^{0} , … , {c}_{M - 1}^{0} \} and \{ {c}_{0}^{1} , {c}_{1}^{1} , … , {c}_{M - 1}^{1} \} .$$

The final cross-component model is

$$\{ ( 1 - α ) \times {c}_{0}^{0} + α \times {c}_{0}^{1} , ( - α ) \times {c}_{1}^{0} \} + α \times {c}_{1}^{1} , … , {c}_{M - 1}^{1} \} .$$

where α is a weighting factor which can be predefined or implicitly derived according to neighbouring template cost, and

$${c}_{x}^{y}$$

is the x-th model parameter of the y-th candidate. For example, by using the template cost defined in the section entitled: Reordering the candidates in the list, the corresponding template cost of two candidates are e^{cand1} and e^{cand2} then α is e^{cand1}/(e^{cand1}+e^{cand2}). For still an example, for the two candidate models, one is from the spatial adjacent neighbouring candidates, and another one is from the non-adjacent spatial candidates or history candidates. If the spatial adjacent neighbouring candidates are not available, then the two candidate models are all from the non-adjacent spatial candidates or history candidates. In another embodiment, if two candidate models are combined, the selected models are from the first two candidates in the list. In still another embodiment, if i candidate models are combined, the selected models are from the first i candidates in the list, where i is an integer greater than 1.

In another embodiment, two cross-component models are combined into one final model by weighted-averaging the corresponding model parameters. One of the two cross-component models is from the above spatial neighbouring candidate and another one is from the left spatial neighbouring candidate. The above spatial neighbouring candidate is the neighbouring candidate that has the vertical position less than or equal to the top block boundary position of the current block. The left spatial neighbouring candidate is the neighbouring candidate that has the horizontal position less than or equal to the left block boundary position of the current block. The weighting factor α is determined according to the horizontal and vertical spatial positions inside the current block. For example, if two candidate predictions (denoted as p_{above} and p_{left}) are combined, the final prediction at (x,y) position of the current block is p_{final}(x,y)=(1−α)×p_{above}(x,y)+α×p_{left}(x,y), where α=y/(x+y). In another embodiment, the above spatial neighbouring candidate is the first candidate in the list that has the vertical position less than or equal to the top block boundary position of the current block. The left spatial neighbouring candidate is the first candidate in the list that has the horizontal position less than or equal to the left block boundary position of the current block.

In another embodiment, it can combine cross-component model candidates with the prediction of non-cross-component coding tools. For example, one cross-component model candidate is selected from the candidate list, and its prediction is denoted as p_{ccm}. Another prediction can be from chroma DM, chroma DIMD, or intra angular mode, and denoted as p_{non-ccm}. The final prediction at (x,y) position of the current block is p_{final}(x,y)=(1−α)×p_{ccm}(x,y)+α×p_{non-ccm}(x,y), where α is the weighting factor which can be predefined or implicitly derived according to neighbouring template cost. For still the same example, the non-cross-component coding tool can be predefined or signalled. The non-cross-component coding tool is chroma DM or chroma DIMD. For another example, the non-cross-component coding tool is signalled, but the index of cross-component model candidate is predefined or determined by the coding modes of neighbouring blocks. For still the same example, if at least one of neighbouring spatial blocks is coded with CCCM mode, the first candidate has CCCM model parameters is selected. If at least one of neighbouring spatial blocks is coded with GLM mode, the first candidate has GLM pattern parameters is selected. Similarly, if at least one of neighbouring spatial blocks is coded with MMLM mode, the first candidate has MMLM parameters is selected.

In another embodiment, it can combine the prediction of cross-component model candidates with the prediction by the current cross-component model. For example, one cross-component model candidate is selected from the list, and its prediction is denoted as p_{ccm}. Another prediction can be from the cross-component prediction mode whose model is derived by the current neighbouring reconstructed samples and is denoted as p_{curr-ccm}. The final prediction at (x,y) position of the current block is p_{final}(x,y)=(1−α)×p_{ccm}(x,y)+α×p_{curr-ccm}(x,y), where a is the weighting factor which can be predefined or implicitly derived according to neighbouring template cost. For still the same example, the prediction by the current cross-component model can be predefined or signalled. The prediction by the current cross-component coding tool is CCCM_LT, LM_LA (i.e., single model LM using both top and left neighbouring samples to derive the model), or MMLM_LT (i.e., multi-model LM using both top and left neighbouring samples to derive the model). In one embodiment, the selected cross-component model candidate is the first candidate in the list.

In another embodiment, it can combine multiple cross-component models into one final cross-component model. For example, it can choose one model from a candidate, and choose a second model from another candidate to form a multi-model mode. The selected candidate can be CCLM/MMLM/GLM/CCCM coded candidate. The multi-model classification threshold can be the average of the offset parameters (e.g., offset/β in CCLM, or c₆×B or c₆ in CCCM) of the two selected modes. In one embodiment, if two candidate models are combined, the selected models are the first two candidates in the list. In another embodiment, the classification threshold is set to the average value of the neighbouring luma and chroma samples of the current block.

Inheriting from Shared Cross-Component Models

In one embodiment, the current picture is segmented into multiple non-overlapped regions, and each region size is M×N. A shared cross-component model is derived for each region, respectively. The neighbouring available luma/chroma reconstructed samples of the current region are used to derive the shared cross-component model of the current region. Then, for a block inside the current region, it can determine whether to inherit the shared cross-component model or derive cross-component model by the neighbouring available luma/chroma reconstructed samples of the block. In one embodiment, the M×N can be a predefined value (e.g. 32×32 regarding to the chroma format), a signalled value (e.g. signalled in sequence/picture/slice/tile-level), a derived value (e.g. depending on the CTU size), or the maximum allowed transform block size.

In another embodiment, each region may have more than one shared cross-component model. For example, it can use various neighbouring templates (e.g., top and left neighbouring samples, top-only neighbouring samples, left-only neighbouring samples) to derive more than one shared cross-component model. Besides, the shared cross-component models of the current region can be inherited from previously used cross-component models. For example, the shared model can be inherited from the models of adjacent spatial neighbours, non-adjacent spatial neighbours, temporal neighbours, or from a historical list.

When doing signalling, a first flag can be used to determine if the current cross-component model is inherited from the shared cross-component models or not. If the current cross-component model is inherited from the shared cross-component models, the second syntax indicate the inherited index of the shared cross-component models (e.g., signalled using truncate unary code, Exp-Golomb code, or fixed length code).

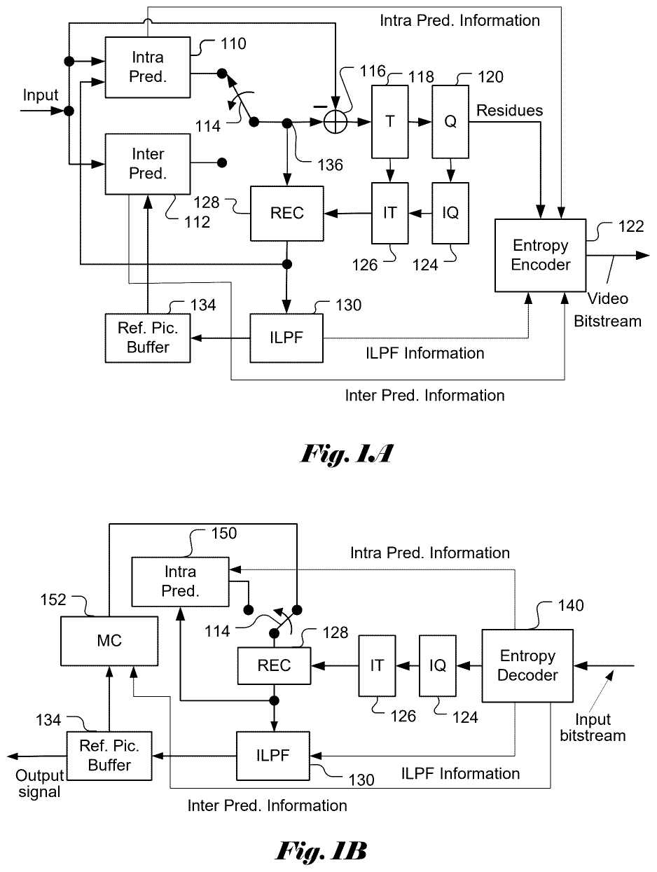

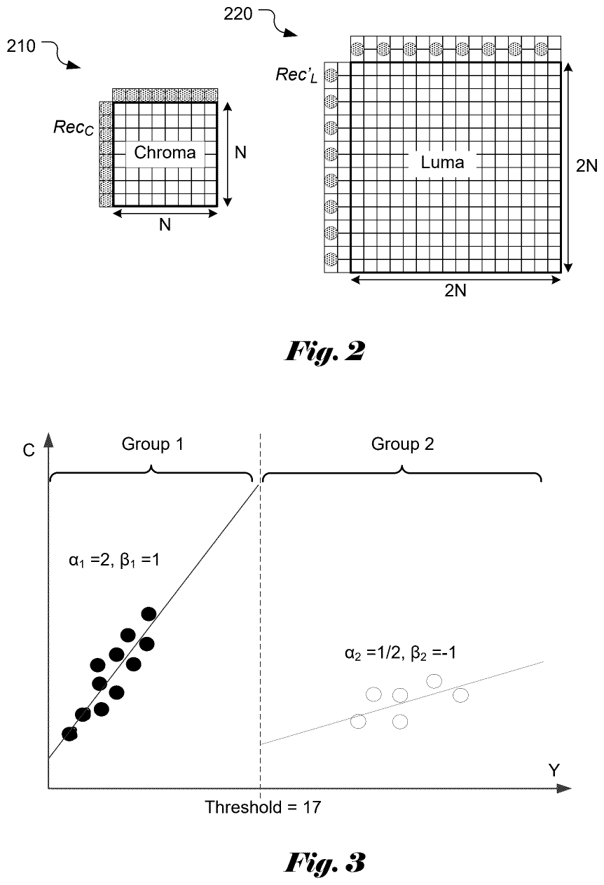

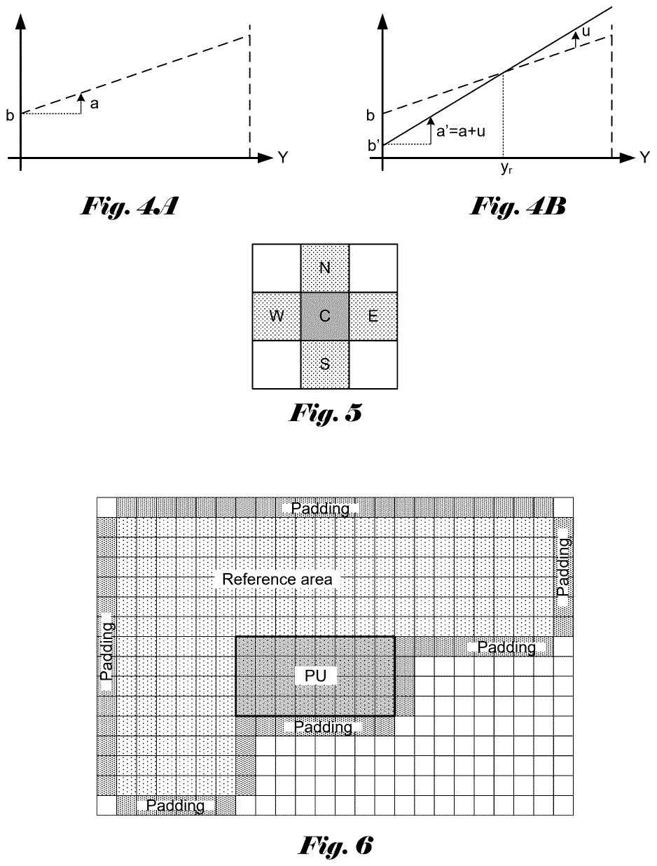

The cross-component prediction with reordered candidates according to types of the candidates or with constrained operations for reordering can be implemented in an encoder side or a decoder side. For example, any of the proposed candidate reordering methods can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed methods can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

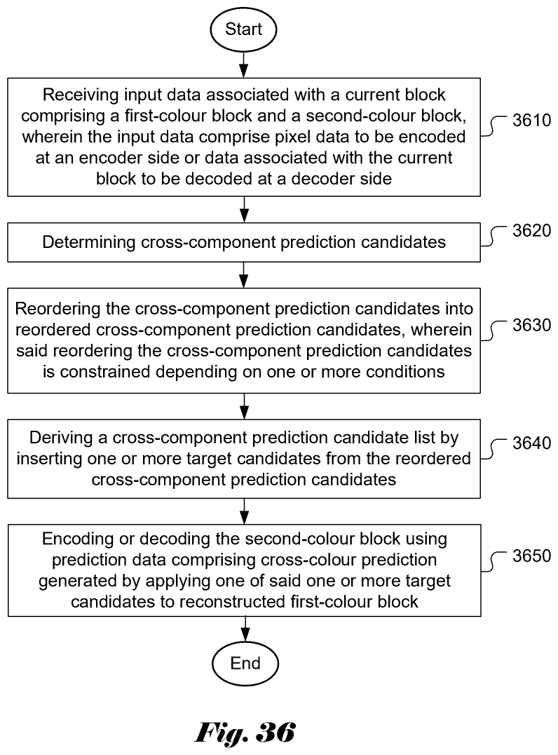

FIG. 36 illustrates a flowchart of an exemplary video coding system that incorporates cross-component candidates reordered with constraints according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block comprising a first-colour block and a second-colour block are received in step 3610, wherein the input data comprise pixel data to be encoded at an encoder side or data associated with the current block to be decoded at a decoder side. Cross-component prediction candidates are determined in step 3620. The cross-component prediction candidates are reordered to generate reordered cross-component prediction candidates in step 3630, wherein said reordering the cross-component prediction candidates is constrained depending on one or more conditions. A cross-component prediction candidate list is derived by inserting one or more target candidates from the reordered cross-component prediction candidates in step 3640. The second-colour block is encoded or decoded using prediction data comprising cross-colour prediction generated by applying one of said one or more target candidates to reconstructed first-colour block in step 3650.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures using coding tools including one or more cross component models related modes, the method comprising:
receiving input data associated with a current block comprising a first-colour block and a second-colour block, wherein the input data comprise pixel data to be encoded at an encoder side or data associated with the current block to be decoded at a decoder side;
determining cross-component prediction candidates;
reordering the cross-component prediction candidates into reordered cross-component prediction candidates, wherein said reordering the cross-component prediction candidates is constrained depending on one or more conditions;
deriving a cross-component prediction candidate list by inserting one or more target candidates from the reordered cross-component prediction candidates; and
encoding or decoding the second-colour block using prediction data comprising cross-colour prediction generated by applying one of said one or more target candidates to reconstructed first-colour block.

2. The method of claim 1, wherein said one or more conditions comprise a size or area of the current block.

3. The method of claim 2, wherein said one or more conditions are determined by comparing the size, width or height of the current block with a threshold.

4. The method of claim 1, wherein the cross-component prediction candidates are categorized into candidate groups and said one or more conditions comprise the candidate groups.

5. The method of claim 4, wherein the reordered cross-component prediction candidates are generated by comparing first candidates from the candidate groups respectively.

6. The method of claim 4, wherein the cross-component prediction candidates are categorized into the candidate groups according to partial or all model parameters associated with cross-component model modes of the cross-component prediction candidates.

7. The method of claim 4, wherein for each of the candidate groups, the cross-component prediction candidates associated with said each of the candidate groups are reordered into a reordered preparatory list based on template costs associated with the cross-component prediction candidates in said each of the candidate groups.

8. The method of claim 7, wherein the reordered preparatory list consists of N1 candidates and N2 candidates of the reordered preparatory list with smallest template costs are inserted into the cross-component prediction candidate list, and N1 and N2 are positive integers and N2 is smaller than or equal to N1.

9. The method of claim 4, wherein the candidate groups correspond to different sources of the cross-component prediction candidates.

10. The method of claim 9, wherein the different sources of the cross-component prediction candidates comprise spatial candidates, temporal candidates, non-adjacent neighbour candidates, historical candidates or a combination thereof.

11. The method of claim 4, wherein the candidate groups correspond to different cross-component model modes of the cross-component prediction candidates.

12. The method of claim 11, wherein the different cross-component model modes of the cross-component prediction candidates comprise CCLM, MMLM, CCCM, CCCM multi-model or a combination thereof.

13. The method of claim 1, wherein when the cross-component prediction candidates are categorized into different types and said one or more conditions comprise the different types, and wherein only partial types of the different types are allowed to be reordered separately before the cross-component prediction candidates are added into the cross-component prediction candidate list.

14. The method of claim 1, wherein a number of comparison operations associated with said reordering the cross-component prediction candidates is constrained to be no greater than a maximum allowed number of comparison operations.

15. The method of claim 1, wherein a number of model error computation operations associated with said reordering the cross-component prediction candidates is constrained when said reordering the cross-component prediction candidates is based on model errors associated with the cross-component prediction candidates.

16. An apparatus for video coding, the apparatus comprising one or more electronics or processors arranged to:
receive input data associated with a current block comprising a first-colour block and a second-colour block, wherein the input data comprise pixel data to be encoded at an encoder side or data associated with the current block to be decoded at a decoder side;
determine cross-component prediction candidates;
reorder the cross-component prediction candidates into reordered cross-component prediction candidates, wherein reordering of the cross-component prediction candidates is constrained depending on one or more conditions;
derive a cross-component prediction candidate list by inserting one or more target candidates from the reordered cross-component prediction candidates; and
encode or decode the second-colour block using prediction data comprising cross-colour prediction generated by applying one of said one or more target candidates to reconstructed first-colour block.
